(19) United States
(12) Patent Application Publication
(10) Pub. No.: US 2011/0257993 A1
(43) Pub. Date: Oct. 20, 2011

(54) AUTOMATED ASSOCIATION OF RATING DIAGNOSTIC CODES FOR INSURANCE AND DISABILITY DETERMINATIONS

(75) Inventor: Marjie SHAHANI, Arcadia, CA (US)

(73) Assignee: QTC MANAGEMENT, INC., Diamond Bar, CA (US)

(21) Appl. No.: 13/050,870

(22) Filed: Mar. 17, 2011

Related U.S. Application Data
(60) Provisional application No. 61/314,978, filed on Mar. 17, 2010.

(51) Int. Cl. G06Q 50/00; G06Q 10/00

(52) U.S. Cl. 705/2

(57) ABSTRACT

A method for adjudicating, for a payor, a medical disability request is described. The method includes receiving an indicator of a diagnosis of a medical condition of a claimant, and presenting to a user by a processor and from a predetermined set of health condition classification codes, at least two health condition classification codes based on the diagnosis. The method also includes receiving from the user a selection of at least one of the at least two health condition classification codes, and associating, based on a disability rating rules collection, the selected at least one health condition classification code with at least one rating diagnostic code selected from a predetermined set of rating diagnostic codes. Systems and machine-readable media are also described.

### CROSS-REFERENCE TO RELATED APPLICATIONS

The present application claims the benefit of priority under 35 U.S.C. §119 from U.S. Provisional Patent Application Ser. No. 61/314,978 entitled “AUTOMATED PROCESSING OF ELECTRONIC MEDICAL DATA FOR INSURANCE AND DISABILITY DETERMINATIONS,” filed on March 17, 2010, the disclosure of which is hereby incorporated by reference in its entirety for all purposes.

### BACKGROUND

1. Field

The present disclosure generally relates to systems and methods for improving the efficiency of performing disability evaluations.

2. Description of the Related Art

Government agencies and insurance companies have developed rules for adjudication of insurance or disability requests. Examples of insurance or disability programs include the Department of Veterans Affairs (V.A.) program, the Social Security Disability Insurance program, the Workers' Compensation program, various property and casualty insurance programs, and so forth.

In order to adjudicate a request made by a claimant, certain medical evidence is required. Medical evidence requirements refers to requirements of information about a claimant that is relevant to the medical conditions claimed by the claimant, such as the age and gender of the claimant, physical examination data, laboratory test data and medical history data pertinent to the claims, and so forth. The requirements are specified by rules developed by the government agency or by the insurance company, pertinent case law, government regulations, legislation and administrative decisions, and so forth. For example, the requirements may specify that if a claimant claims a certain medical condition, a medical provider must conduct certain physical examinations and laboratory tests on the claimant or ask certain questions. The requirements may also specify, for example, that a claimant must have a range of motions less than a certain degree to claim a limb disability. Requirements can also be specified by conventional medical knowledge, for example requiring a certain test to confirm a particular claimed condition.

The rating rules are normally documented in manuals that may have many different titles, herein referred to as “rating books.” A rating code refers to a classification used by the government agency or insurance company that typically refers to a medical condition or a class of medical conditions in a rating book. The collection of rating rules, rating codes, pertinent legislation and case law for an insurance or disability program is herein referred to as the “rules collection” for that program. The rating rules may include rules on how to make a rating decision based on the collected medical evidence and the rating codes. For example, in a V.A. disability program, the rules collection typically specifies a disability percentage range based on rating codes and collected medical evidence. A V.A. rating personnel reviews the rating codes and medical evidence, and specifies a disability percentage within the range.

In a disability or insurance request process, the claimant typically visits a hospital, clinic or medical office. A medical provider such as a physician or a nurse collects medical evidence from the claimant to support a rating decision. The rating decision is typically made by the government agency or the insurance company based on the medical evidence collected by the medical provider and based on the rules collection. The medical providers are typically provided with documents generally referred to as “physician's disability evaluation” or “medical examination handbooks” to assist them with collecting medical evidence. The handbooks are herein referred to as “medical handbooks”. The medical handbooks typically contain the medical evidence requirements for the rules collection.

Whereas the rating books are typically intended for the rating personnel in the government agency or insurance company, the medical handbooks are typically intended for the medical providers. Although they are somehow related, the rating books and medical handbooks typically contain very few direct cross-references. In addition, the medical providers often are not familiar with the rules collection of the insurance or disability program, and make mistakes in using the medical handbooks.

This process of performing disability examinations includes many challenges. These challenges include an increasing number of claims, an increasing complexity of the claims, an increasing number of claimed conditions, and changes in laws and regulations. As a result, an increased number of rating personnel is required to perform such examinations. The need for an increased number of rating personnel requires experienced rating personnel to dedicate time to train new rating personnel. Training is extensive and includes gaining both regulatory and medical knowledge. Such regulatory and medical knowledge includes learning about many resources used to complete a rating decision, including: Title 38 Code of Federal Regulations (CFR 38), the M21-1(MR), Fast Letters, claimant file (C-file) evidence, and combined tables which contribute to the complexities of the rating process.

To better illustrate the drawbacks of conventional practices and the need for better systems, the V.A. Compensation and Pension (C&P) program is described as an example. This government program provides payments of benefits to military veterans for medical disability resulting from their military service. The rating rules are included in the Code of Federal Regulations 38-CFR, the governing legislation, and in a rating book. The related medical handbook is a series of documents titled Automatic Medical Information Exchange (AMIE) worksheets. These worksheets specify the medical evidence required and the procedures to be utilized for each claimed condition included in 38-CFR. There are currently over fifty separate AMIE worksheets covering a wide array of claims, from a Prisoner of War Protocol Examination to Scars Examination. Each worksheet is designed as a stand-alone medical document for the particular claimed disability. In addition to the AMIE worksheets, legislatively mandated requirements, administrative requirements, and court ordered information have, from time to time, specified other medical evidence or dictated the manner in which it is to be collected. Significant training and experience is required to familiarize medical providers with the worksheets and the additional requirements. Significant delays and extra cost in claims processing are encountered when required medical evidence is not provided or incorrect procedures are conducted. Additionally, the claimant frequently claims multiple disabilities. These can number up to twenty or more claims for one claimant. The current practice is to complete an AMIE worksheet with all the requirements for each claimed disability. This results in unnecessary duplication of procedures with the entailed extra costs and time.

### SUMMARY

Certain embodiments disclosed herein are directed to a system for improving the rating process for making disability determinations, such as by expanding the role of an examining physician in providing medical knowledge and expertise with an information technology tool configured to organize medical evidence and link it to rating criteria.

In certain aspects, a method for adjudicating, for a payor, a medical disability request is disclosed. The method includes receiving an indicator of a diagnosis of a medical condition of a claimant, and presenting to a user by a processor and from a predetermined set of health condition classification codes, at least two health condition classification codes based on the diagnosis. The method also includes receiving from the user a selection of at least one of the at least two health condition classification codes, and associating, based on a disability rating rules collection, the selected at least one health condition classification code with at least one rating diagnostic code selected from a predetermined set of rating diagnostic codes. Each of the at least two health condition classification codes represents a classification of at least one of an injury, disease, sign, symptom, abnormal finding on a physical exam, abnormal lab finding, claimant complaint, social circumstance, and an external cause of an injury or a disease. The at least one rating diagnostic code is configured to determine a degree of disability of the claimant and an indicator of an amount of money to be paid to the claimant by the payor.

In certain aspects, a system for adjudicating, for a payor, a medical disability request is disclosed. The system includes a memory comprising instructions, and a processor. The processor is configured to execute the instructions to receive an indicator of a diagnosis of a medical condition of a claimant, and present, to a user, by a processor and from a predetermined set of health condition classification codes, at least two health condition classification codes based on the diagnosis. The processor is also configured to execute the instructions to receive, from the user, a selection of at least one of the at least two health condition classification codes, and associate, based on a disability rating rules collection, the selected at least one health condition classification code with at least one rating diagnostic code selected from a predetermined set of rating diagnostic codes. Each of the at least two health condition classification codes represents a classification of at least one of an injury, disease, sign, symptom, abnormal finding on a physical exam, abnormal lab finding, claimant complaint, social circumstance, and an external cause of an injury or a disease. The at least one rating diagnostic code is configured to determine a degree of disability of the claimant and an indicator of an amount of money to be paid to the claimant by the payor.

In certain aspects, a machine-readable storage medium comprising machine-readable instructions for causing a processor to execute a method for adjudicating, for a payor, a medical disability request is disclosed. The method includes receiving an indicator of a diagnosis of a medical condition of a claimant, and presenting to a user by a processor and from a predetermined set of health condition classification codes, at least two health condition classification codes based on the diagnosis. The method also includes receiving from the user a selection of at least one of the at least two health condition classification codes, and associating, based on a disability rating rules collection, the selected at least one health condition classification code with at least one rating diagnostic code selected from a predetermined set of rating diagnostic codes. Each of the at least two health condition classification codes represents a classification of at least one of an injury, disease, sign, symptom, abnormal finding on a physical exam, abnormal lab finding, claimant complaint, social circumstance, and an external cause of an injury or a disease. The at least one rating diagnostic code is configured to determine a degree of disability of the claimant and an indicator of an amount of money to be paid to the claimant by the payor.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates the general overview of one embodiment of a disability benefits claims system.

FIG. 2 illustrates one embodiment of an arrangement of modules and sub-modules.

FIG. 3 illustrates one embodiment of an arrangement of categories and sub-categories.

FIG. 4 illustrates one embodiment of a process of organizing rules collection into a knowledge library.

FIG. 5 illustrates one embodiment of a process of generating claimant-specific medical evidence queries.

FIG. 6 illustrates one embodiment of a data entry form for claimed medical conditions.

FIGS. 7A-7D illustrate one embodiment of a medical provider's exam protocol.

FIGS. 8A-8E illustrate one embodiment of a claimant questionnaire.

FIGS. 9A-9B illustrate one embodiment of a narrative medical report.

FIG. 10 illustrates one embodiment of a diagnostic code summary medical report.

FIGS. 11A-11H illustrate one embodiment of a rating report.

FIG. 12 illustrates an exemplary client and server in an architecture for adjudicating a medical disability request.

FIG. 13 illustrates an exemplary process for adjudicating, for a payor, a medical disability request using the exemplary client of FIG. 12.

FIGS. 14 and 15 are exemplary screenshots from the process of FIG. 13.

FIG. 16 is a block diagram illustrating an exemplary computer system with which the clients and servers of FIG. 1 can be implemented.

### DETAILED DESCRIPTION

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail not to obscure the disclosure.

Overview of Disability Benefits Claims System

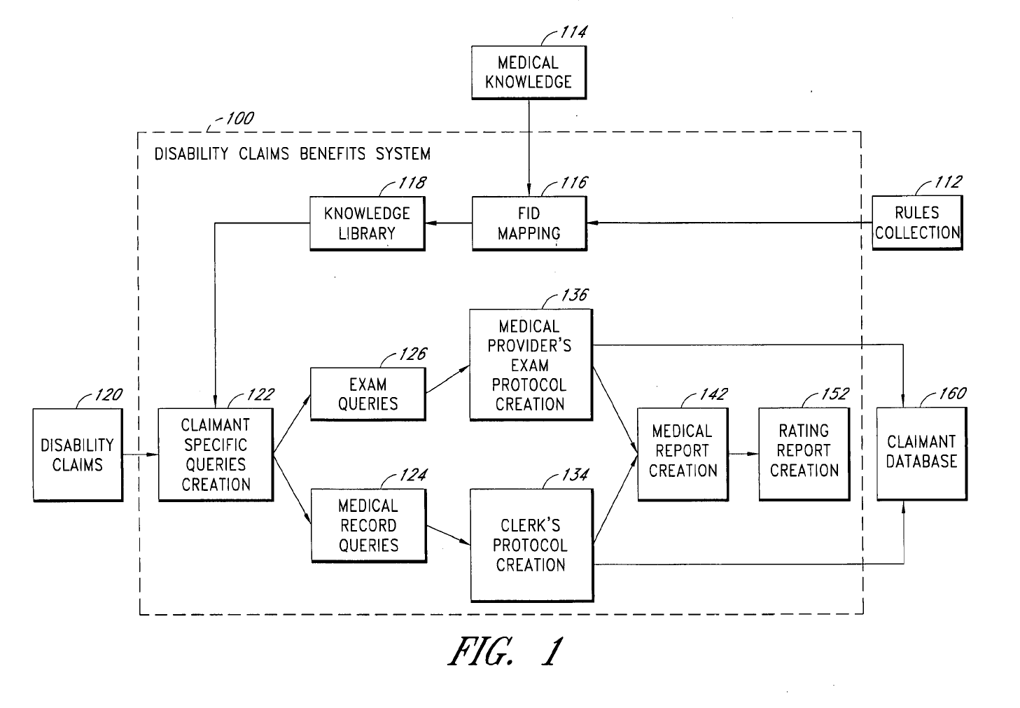

FIG. 1 illustrates the general overview of one embodiment of a disability benefits claims system 100. The rules collection 112 for the insurance or disability program and pertinent medical knowledge 114 are organized by a FID mapping component 116 into a knowledge library 118. Based on the claimed medical conditions 120 from a claimant and based on the rules collection or medical knowledge stored in the knowledge library 118, the claimant-specific query creation module 122 creates claimant-specific medical evidence queries.

The queries are then separated into medical record queries 124 for medical records, and exam queries 126 for physical exams and laboratory tests. The medical record queries 124 for medical records may be used by the clerk's protocol creation component 134 to create a clerk's data collection protocol to collect the required data from medical records. Alternatively, the medical record queries 124 may trigger an electronic records querying component (not shown) that facilitates the collection of the required data from electronic medical records (EMR) stored in the claimant database 160.

The exam queries 126 for exams and tests may be used by the medical provider's exam protocol creation component 136 to create a medical provider's data collection protocol to assist a physician, nurse or technician in reviewing and extracting data from charts, radiological study results, nuclear medicine laboratory results, present medication, allergy and chronic condition lists (e.g., from medical alert bracelets) and other medical records of the patient. The exam protocol creation component 136 may also be used to create a medical provider's data collection protocol to assist the medical provider in conducting histories of the present illness, past medical histories, family and social histories, a review of systems, physical exams, laboratory tests, interviews with friends and family of the claimant, and interviews of the claimant's prior medical providers. The component 136 may also use the exam queries 126 to create a questionnaire to be answered by the claimant. The medical report creation component 142 uses the medical evidence collected from exams, tests, reviews, histories, interviews, claimant questionnaires and medical records to create a medical report. The rating report creation component 152 creates a rating report to assist rating personnel in adjudicating the claims. The collected medical evidence can also be stored in the claimant database 160.

Ortanizint Rules Collection into Knowledte Library

Still referring to FIG. 1, component 112 represents the rules collection for the insurance or disability program, typically embodied in rating books, legislation, administrative decisions and case law. Component 114 represents pertinent medical knowledge, such as instructions to a physician, lab technician or nurse for performing a physical exam or laboratory test. The rules collection and medical knowledge are organized by a FID mapping component 116 into FIDs and stored in a knowledge library component 118.

In a preferred embodiment, every unit of data that may be required by the rules collection for making a rating decision is identified by a field identification number (FID). Examples of FID data fields include a “patient name” field, a “heart rate” field, an “impaired limb motion range” field, and so forth. Each general medical evidence query is identified by a FID. A general medical evidence query corresponds to a medical evidence requirement specified by the rules collection or by medical knowledge. A claimant-specific medical evidence query is generated from the general medical evidence queries and based on the claimant's claimed medical conditions. Claimant-specific queries are described in the subsection titled “Generating claimant-specific medical evidence queries”.

In a preferred arrangement, each FID includes a category code, a rating code and a data query code, separated by the underline symbol “_”. For example, a FID can take the form of “H047_SM500_T001”. The category code “H047” identifies the FID to a category of queries concerning the right knee. The rating code “SM500” identifies the FID to a particular rating code for musculoskeletal injuries in a rating book. The data query code “T001” identifies the FID to the data query “What is the range of motion?.” In another example, the FID mapping number is “TK10_TS6600_T001”. The category code “TK10” represents a category of queries concerning bronchitis. The rating code “TS6600” represents a rating book rating code “6600”. The data query code “T001” represents the query “What is the FEV1 value?.” A query text table stores the data query codes and the query text for each of the data query codes. The table may also store a long instruction text for each data query code as an instruction or explanation. The stored query text and long instruction text can be later displayed in a medical provider's exam protocol, history or interview protocol, claimant questionnaire, clerk's data collection protocol, medical report or rating report.

A FID can take other forms. For example, in a relational database arrangement, a rating code table can store the rating code for each data query code, and a category code table can store the category code for each data query code. Therefore a FID need only include a data query code, and the rating code and category code for the FID can be identified by referencing the rating code table and the category code table. In an object-oriented arrangement, a FID can be an object that includes a data query object field, a rating code object field and a category code object field.

The FID mapping component 116 organizes the rules collection into a plurality of FIDs. For example, for a rating code that identifies diabetes in a V.A. rules collection, the component 116 creates a plurality of FIDs, with each FID identifying a unit of medical evidence required for making a rating decision on the diabetes claim. Each FID preferably includes a category code, the V.A. rating code that identifies diabetes, and a data query code. For example, one FID includes a data query code representing the data query “Have you served in the Vietnam War?” because V.A. rules assume that Vietnam veterans' diabetes conditions are caused by exposure to Agent Orange. As described above, the data query code may be further associated with a long instruction text “If claimant has served in Vietnam and suffers from diabetes, assume that service connection exists.”

Arrangement of Modules and Sub-modules, Categories and Sub-categories

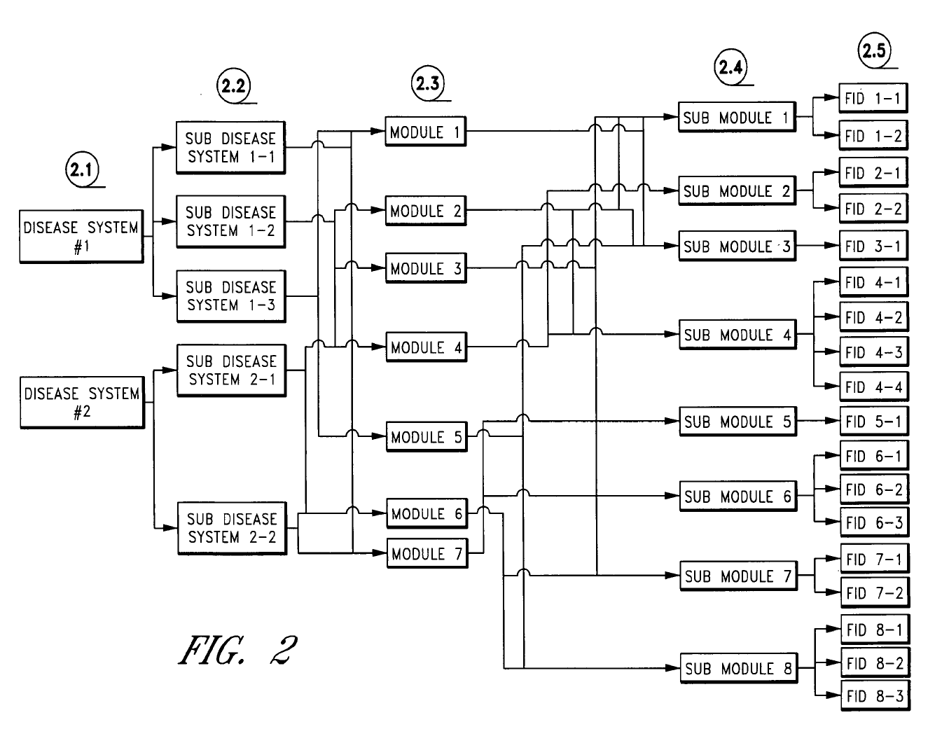

FIG. 2 illustrates one embodiment of a disability benefits claims systems 100 that includes modules and sub-modules. A rating book typically classifies medical conditions into disease systems, also called body systems. Typical disease systems may include the cardiovascular system, the respiratory system, infectious diseases, and so forth. Some rating books classify a disease system into one or more sub-disease systems or sub-body systems. For example, a “cardiovascular disease system” may include sub-disease systems such as myocardial-infarction sub-disease system, arrhythmia sub-disease system, and so forth. A sub-disease system is typically unique to one disease system and is not shared by multiple disease systems.

As shown in FIG. 2, each sub-disease system is mapped to one or more modules of the disability benefits claims system 100. A module represents a function within the sub-disease system. For example, the lung sub-disease system can be mapped to a “history of symptoms” module, a “history of general health” module, a “physical examination of the lungs” module, and so forth. In one embodiment, sub-disease systems can share common modules. In one embodiment, modules are assigned priority numbers that identify a priority order among the modules.

Each module can include one or more sub-modules. For example, a “vital signs” sub-module can include data about the height, weight, pulse, and blood pressure of the claimant. A sub-module includes one or more FIDs. Modules can share common sub-modules. For example, the “vital signs” sub-module can be shared by multiple modules because vital signs information is needed for the diagnosis of many diseases and conditions. In one embodiment, sub-modules are assigned priority numbers that identify a priority order among the sub-modules.

A sub-module includes one or more FIDs. For example, the “vital signs” sub-module includes a “height” FID, a “weight” FID, a “pulse” FID and a “blood pressure” FID. In a preferred embodiment, each FID belongs to only one sub-module. In one arrangement, each FID includes a sub-module code that identifies the sub-module of the FID. In another embodiment, a sub-module table in the knowledge library 118 stores the FIDs for each sub-module.

In other embodiments, modules and sub-modules are not introduced. Each rating code and its general medical evidence queries directly correspond to a collection of FIDs. The FID collections for two rating codes may share one or more FIDs.

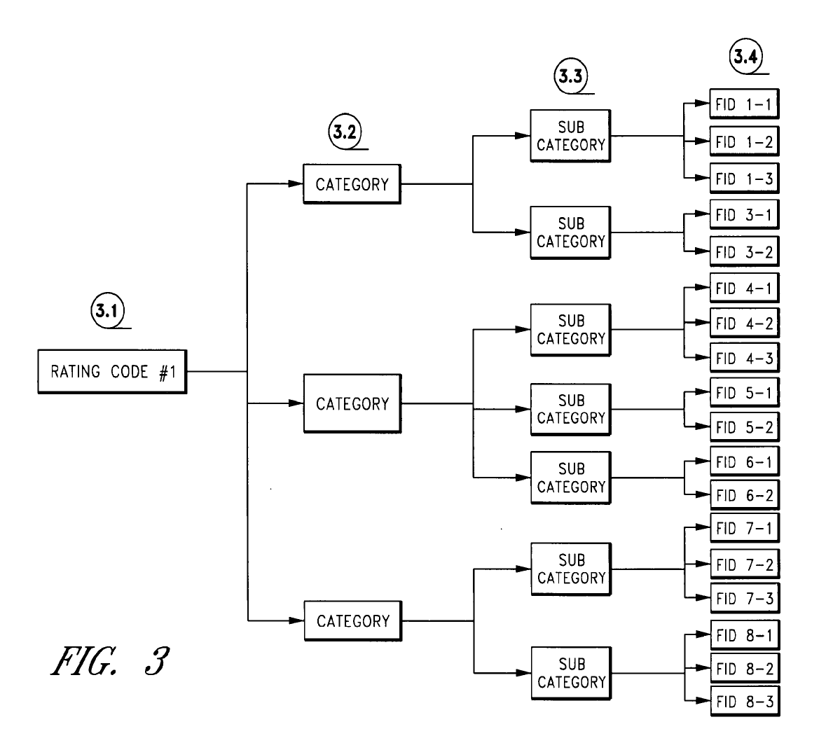

Referring to FIG. 3, the unique data elements that make up the rules collection are grouped by category and sub-category. The categories and sub-categories preferably relate to classifications in the rating books. For example, categories can include “General”, “Complications”, “Function”, “Symptoms”, “Tests”, and so forth. A category can be further classified into one or more sub-categories. For example, the “Function” category includes the sub-categories “ability” and “restriction”. The “Tests” category can include sub-categories “confirmation,” “essential,” “indication,” and “results.” A sub-category includes one or more FIDs.

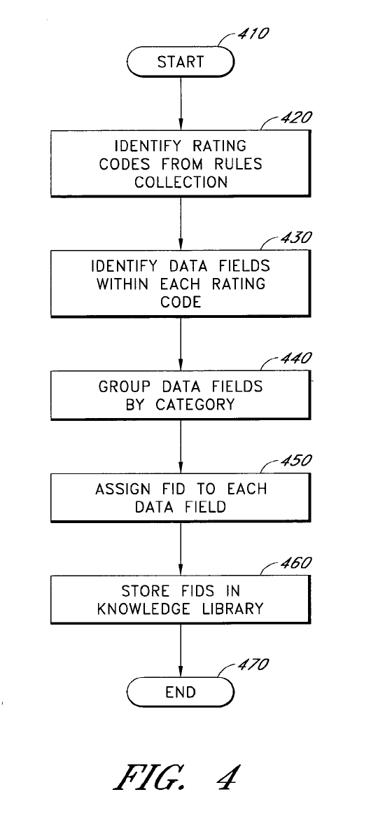

FIG. 4 illustrates one embodiment of a process of organizing rules collection into FIDs. From a start block 410, the process proceeds to a block 420 to identify rating codes from the rating books for the disability or insurance program. The process then proceeds to a block 430 to identify data fields within each rating code. Each data field represents a general medical evidence query. Data fields may also be identified based on pertinent medical knowledge, for example the knowledge of a experienced physician that certain medical evidence are needed to make a rating decision for a particular rating code. Data fields may also be identified based on case law and administrative decisions, for example the Deluca case and required “Deluca issues.”

The process then proceeds to a block 440 to group the data fields by category. In another embodiment, data fields are grouped by sub-category. The process proceeds to a block 450, where a FID is assigned to each data field. In a preferred embodiment, a category code, a rating code and a data query code is assigned to each FID. The category code represents the category the data field is grouped into. The rating code represents the rating code for the data field. The data query code represents the data query for the medical evidence query. The process then proceeds to a block 460 to store the FIDs in a knowledge library component 118. The process terminates at an end block 470.

Generating Claimant-specific Medical Evidence Queries

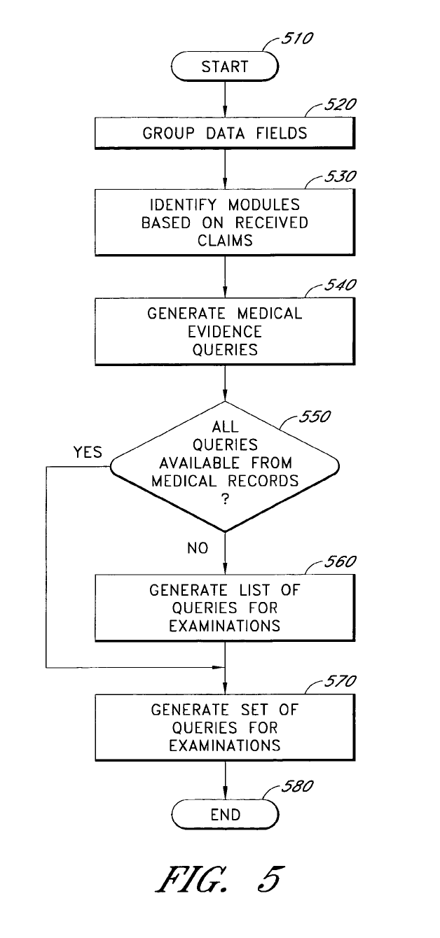

In FIG. 1, the claimant-specific query creation module 122 receives the claimed medical conditions 120 from the claimant, and creates claimant-specific medical evidence query based on the claims and by referring to the general medical evidence queries stored in the knowledge library 118. As would be well-understood by those of skill in the art, the claimed medical conditions 120 might comprise physical, psychiatric, substance abuse disorders or other abnormalities, and are typically stored in any of a variety of computer-readable storage media. FIG. 5 illustrates one embodiment of the query-creation process.

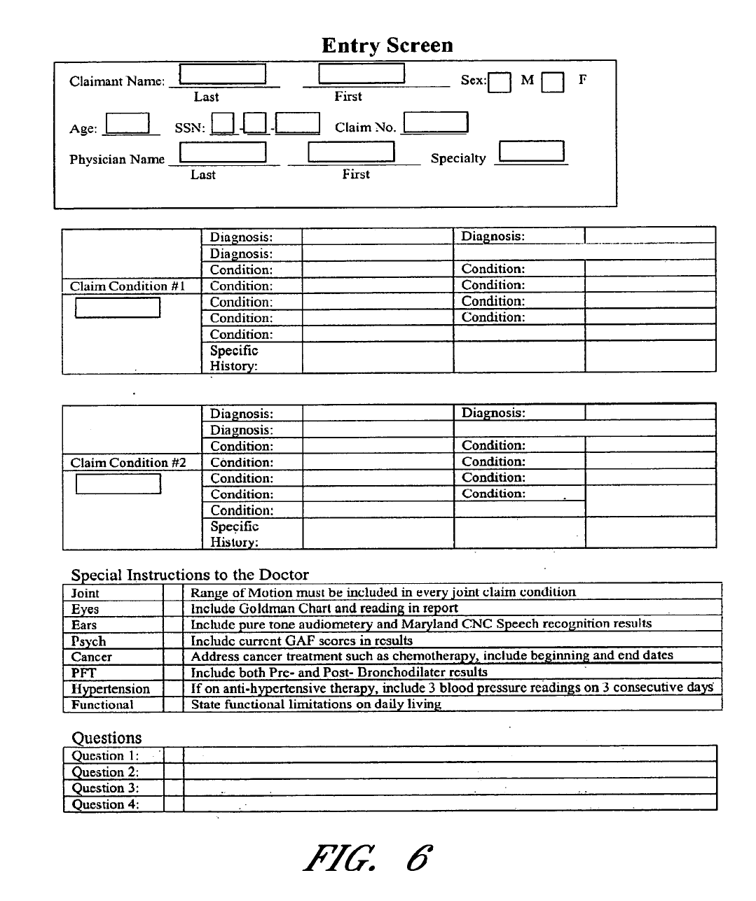

Referring to FIG. 5, the process starts from a start block 510 and proceeds to a block 520, where the query creation component 122 receives one or more claims of medical conditions from the claimant. In one embodiment, the component 122 also receives other information provided by the claimant, for example information such as claimant name, age, gender filled out by the claimant on a data entry form. FIG. 6 is an example data entry form. It can be filled out by the claimant or by a clerk. The “Special Instructions to the Doctor” section displays special instructions retrieved from the knowledge library 118 for the particular insurance or disability program and displayed as a reminder to the medical provider.

Referring back to FIG. 5, at a block 530, the component 122 identifies the related modules based on the received claims. For example, if the claimed condition is “loss of eyesight,” the component 122 may identify a “physical exam” module and a “neurological exam” module. The relationships of medical conditions and related modules are stored in the knowledge library 118. The component 122 also identifies all sub-modules of the identified modules. If two of the identified modules share common sub-modules, the duplicate sub-modules with the lower priority numbers are removed. From all of the FIDs that belong to the identified modules, the duplicate FIDs can also be removed. In other embodiments, instead of identifying the related modules based on the received claims, the component 122 identifies the related sub-modules, the related categories, or the related sub-categories. In another embodiment, the component 122 directly identifies the related FIDs stored in the knowledge library 118 based on the received claims.

At a block 540 of FIG. 5, the component 122 selects those FIDs in the knowledge library 118 that belong to the identified modules and sub-modules. The selected FIDs form a set of the claimant-specific medical evidence queries. The set can be stored in a variety of formats, for example as a text string with FIDs separated by field delimiters such as colons or semicolons, as a text file with a FID in each line, as a table with each FID as a record, as a series of objects with each FID having a “next FID” pointer that points to the next FID object, and so forth. This set of queries is preferably stored in a computer-readable storage, such as hard disk storage, solid state RAM, etc, and this data storage may be implemented using any type of computer storage device or devices, and using any type or types of data repositories (e.g., relational databases, flat files, caches, etc.).

In one embodiment, the component 122 compares the information already received from the claimant, and fills the related FIDs with such information. For example, if the claimant has provided his or her name, age and gender, the component then fills the related FIDs with the claimant-provided information. The details of filling a FID with collected medical evidence are described below in more detail.

From the block 540, the process proceeds to a block 550, where the component 122 determines which of the generated claimant-specific queries may be satisfied from medical records. In another embodiment, a human operator reviews the generated queries and determines which of the queries may be satisfied from medical records. In still another embodiment, the component 122 accesses a claimant's EMR and determines which generated claimant-specific queries may be satisfied from the EMR. In other embodiments, instead of determining on a per FID basis, the determination can also be made on a per module, per sub-module, per category or per sub-category basis.

If all generated queries may be obtained from medical records, electronic or paper-based, then the process proceeds to block 570. Otherwise the process proceeds to a block 560, where the component 122 generates a set of claimant-specific queries to be satisfied from physical exams, histories and interviews, claimant questionnaires, laboratory tests, or other medical provider input. At the block 570, the component 122 generates a set of queries whose results can be obtained from existing medical records. The claimant-specific queries generated at the block 540 are thus separated into two sets of queries. In another embodiment, the queries generated at the block 540 are separated into three sets: one set of queries to be satisfied from physical exams, histories, interviews and claimant questionnaires, another set to be satisfied from laboratory tests, and a third set to be satisfied from medical records.

Referring back to the blocks 530 and 540 of FIG. 5, when the claimant submits claims for multiple conditions, it is possible that some of the modules are identified more than once by the claims. The component 122 searches for duplicate modules and eliminates such duplications. In other embodiments, the component can also search for and eliminate duplications on the sub-module or FID level.

Each module is associated with a priority number stored in the knowledge library 118. In the case where multiple modules are called that examine the same sub-disease system, the duplicate modules with the lower priority numbers are eliminated. In another embodiment, each FID is associated with a priority number stored in the knowledge library 118.

In one embodiment, the generated queries can be updated by a human operator. For example, a medical provider or rating personnel reviews the generated claimant-specific queries and adds, modifies or deletes one or more queries. This allows some flexibility and human control in the system 100. The human operator can also change the order of generated claimant-specific queries determined by the priority numbers.

The component 122 also checks special rules stored in the knowledge library 118 for exceptions and updates. Exceptions and updates are typically caused by changes in legislation, case law, and insurance or disability program rules. For example, special rules that represent the Deluca case decision can be stored in the knowledge library 118. The stored Deluca special rules can be associated with FIDs, categories or modules stored in the knowledge library 118. When the generated claimant-specific queries include a FID associated with a special rule, the special rule is retrieved from the knowledge library 118 and applied to include a special rule instruction with the FID, or to add, modify or remove other claimant-specific queries. The special rule can also change the order of generated claimant-specific queries determined by the priority numbers.

Creating Medical Provider's and Clerk's Data Collection Protocols

Referring back to FIG. 1, based on the generated set of claimant-specific queries for exams, the medical provider's protocol creation component 136 may create a medical provider's data collection protocol, also called a physician's exam protocol. The component 136 may also create a claimant questionnaire based on the claimant-specific queries. Based on the generated set of claimant-specific queries for medical records, the clerk's protocol creation component 134 may create a clerk's data collection protocol. The generated set of claimant-specific queries may also trigger an electronic records querying component (not shown) that facilitates the collection of the required data from EMR.

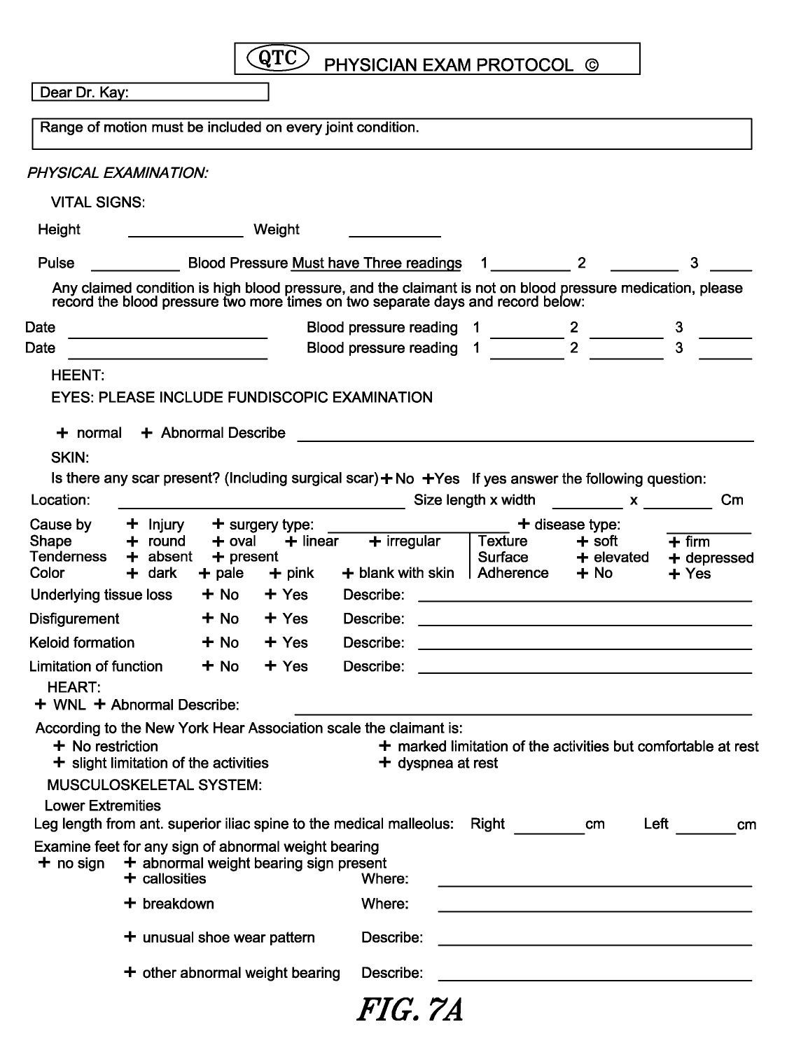

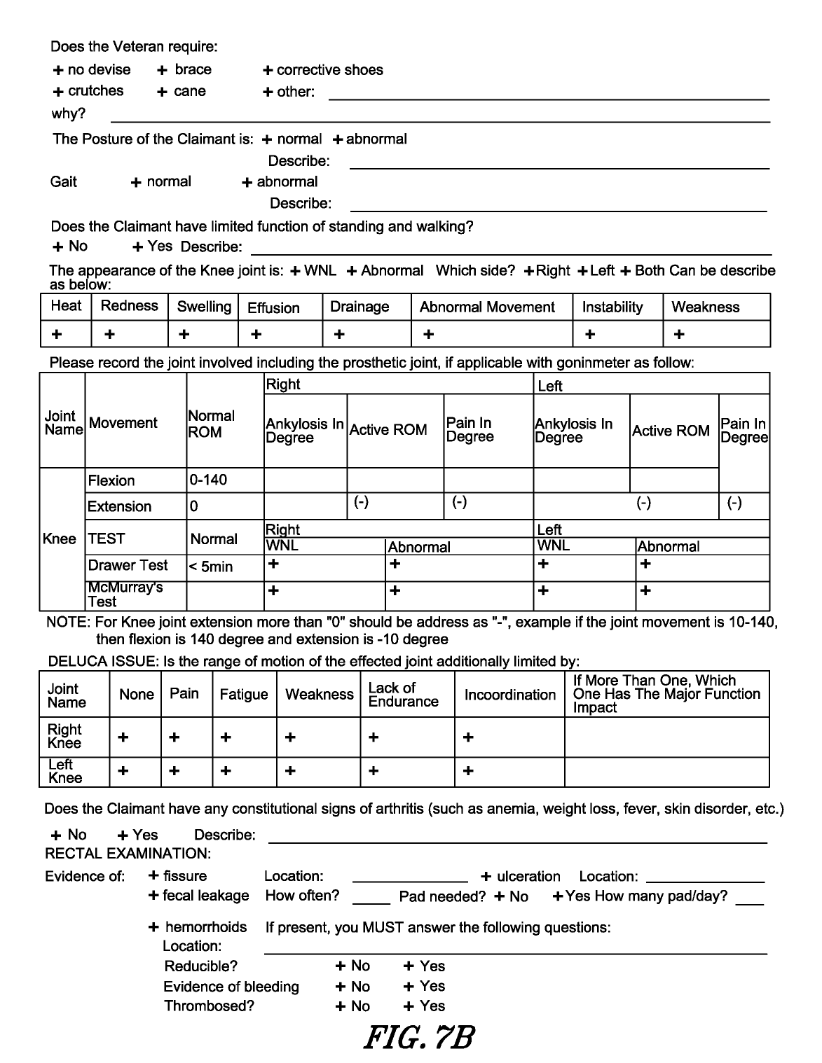

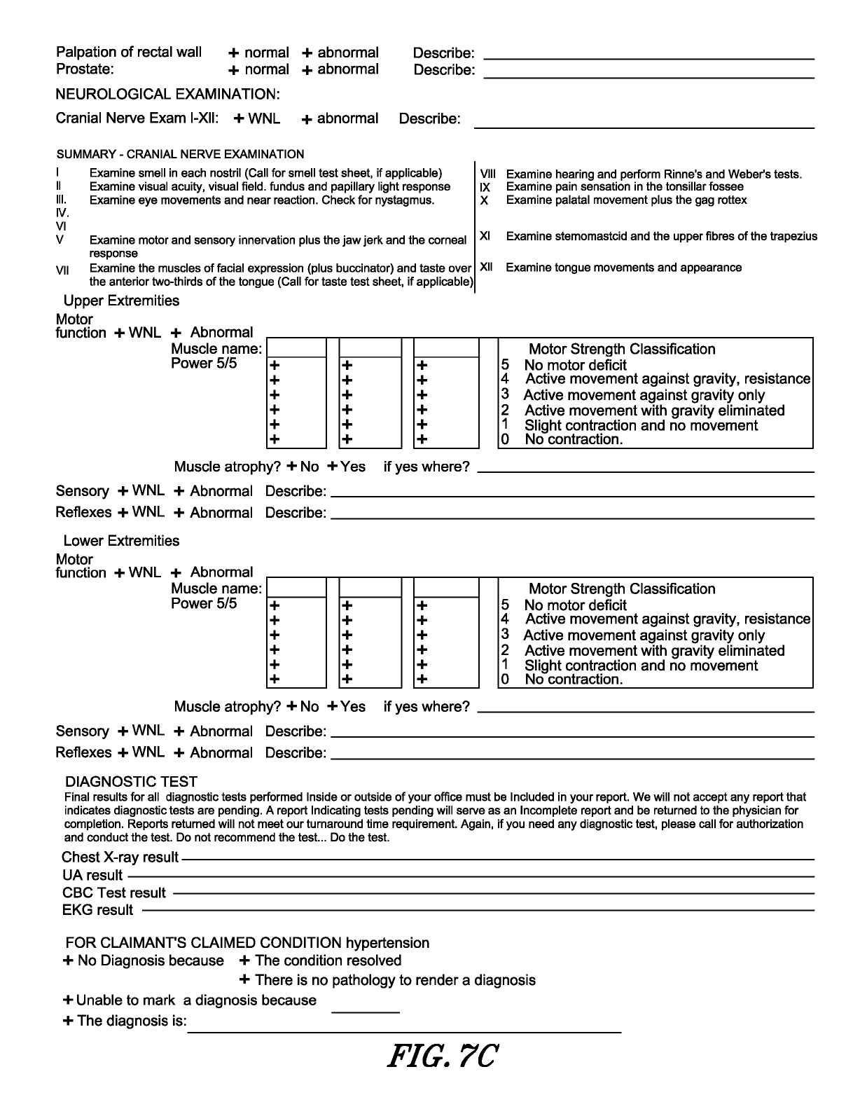

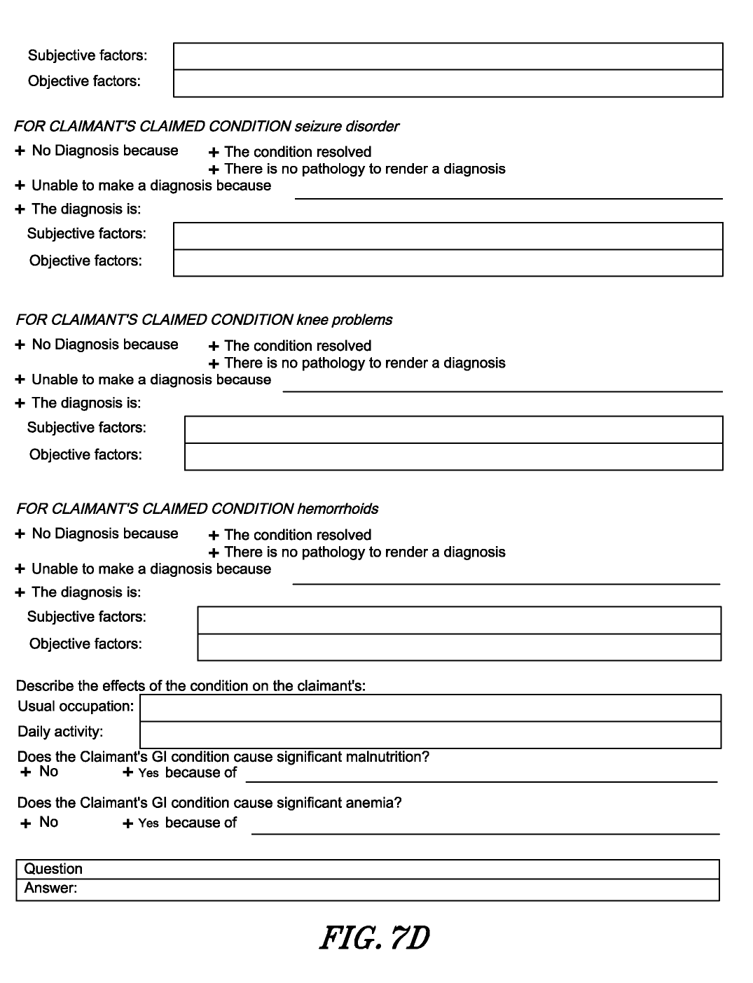

FIGS. 7A-7D illustrate an example medical provider's data collection protocol. The protocol lists the claimant-specific medical evidence queries to be satisfied from physician exams and laboratory tests. In the embodiment shown in FIGS. 7A-7D, the queries are grouped by category and sub-category. For example, the category “PHYSICIAL EXAMINATION” shown in FIG. 7A includes sub-categories “VITAL SIGNS”, “HEENT”, “EYES”, “SKIN”, “HEART”, and “MUSCULOSKELETAL SYSTEM”. The grouping of categories and sub-categories presents the queries in a user-friendly order to the medical provider.

The medical provider uses the exam protocol to examine the claimant, and preferably enters collected medical evidence into the protocol. In one embodiment, the exam protocol is displayed to the medical provider on the screen of an electronic device such as a computer or a personal digital assistant, and the medical provider enters the collected medical evidence corresponding to each query into the electronic device. In another embodiment, the exam protocol is displayed to the medical provider in a paper report, and the medical provider enters the collected medical evidence on the paper report for a clerk to enter into a computer system.

The medical evidence collected by the medical provider is then stored into the disability claims benefits system 100. In one embodiment, for each generated claim-specific query and its FID, the corresponding medical evidence is simply inserted into the end of the FID. For example, for the FID “H047_SM500_T001” described above, if the medical provider determines that the range of motion is 90 degrees, then the FID becomes ““H047_SM500_T001 90”, with the last field within the FID storing the value of the medical evidence. In another embodiment, a table includes a “original FID” field that stores the FID of each query, and a “data value” that stores the medical evidence value of the corresponding FID. Other embodiments can also be implemented.

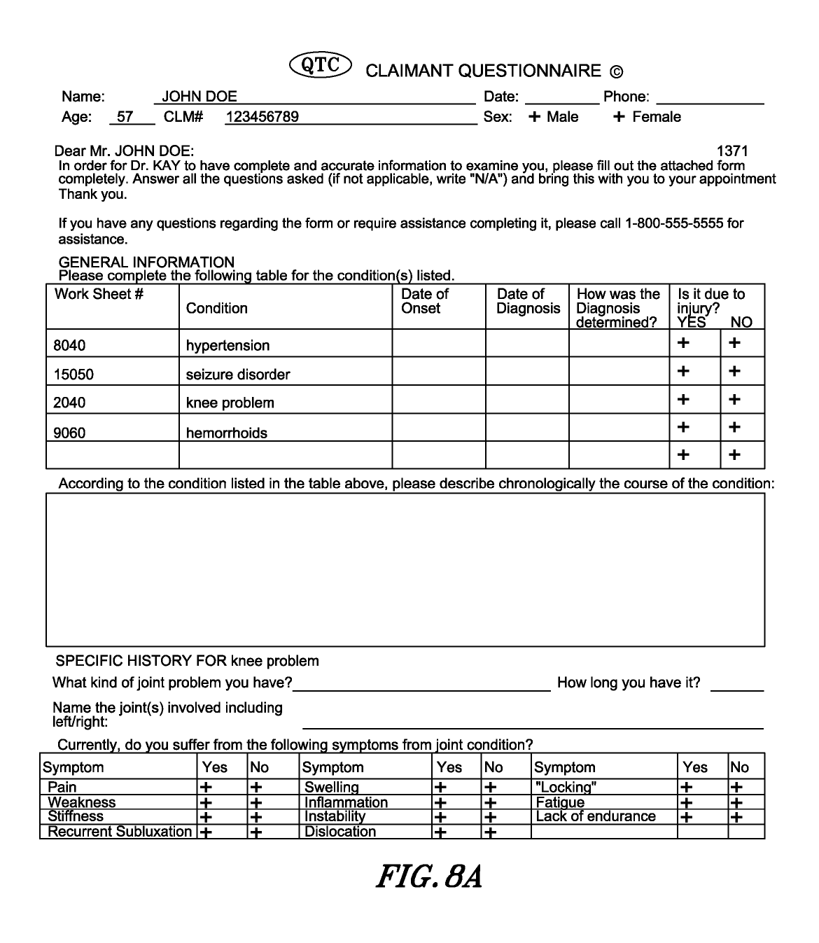

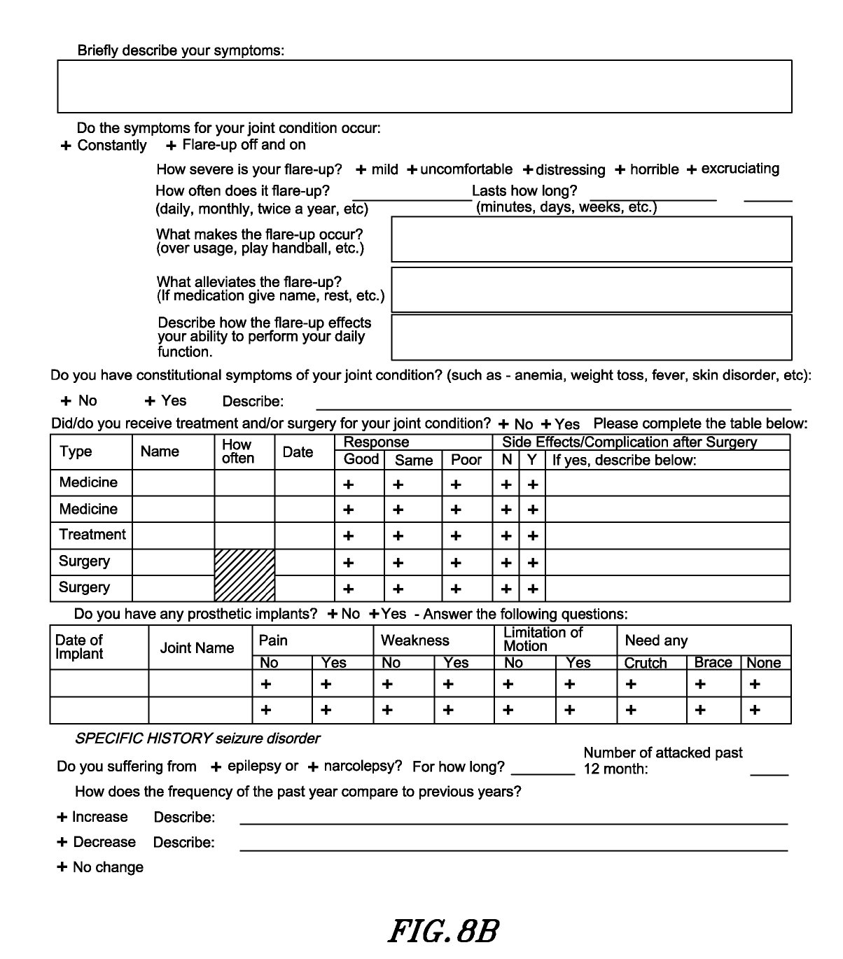

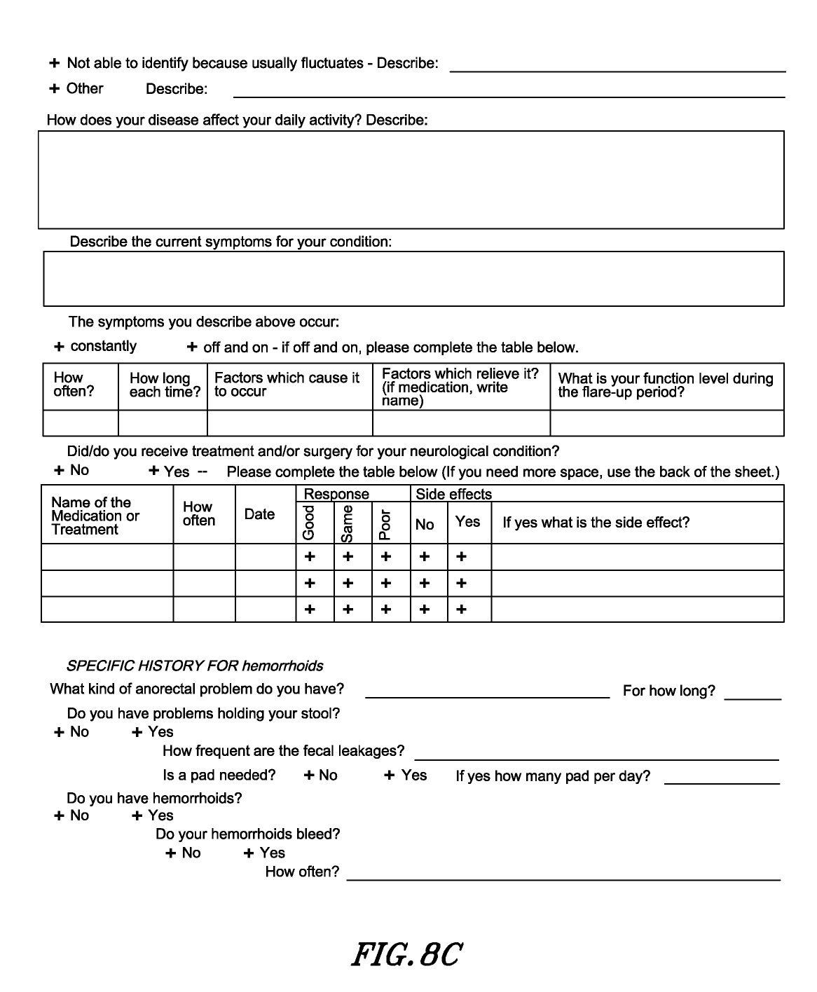

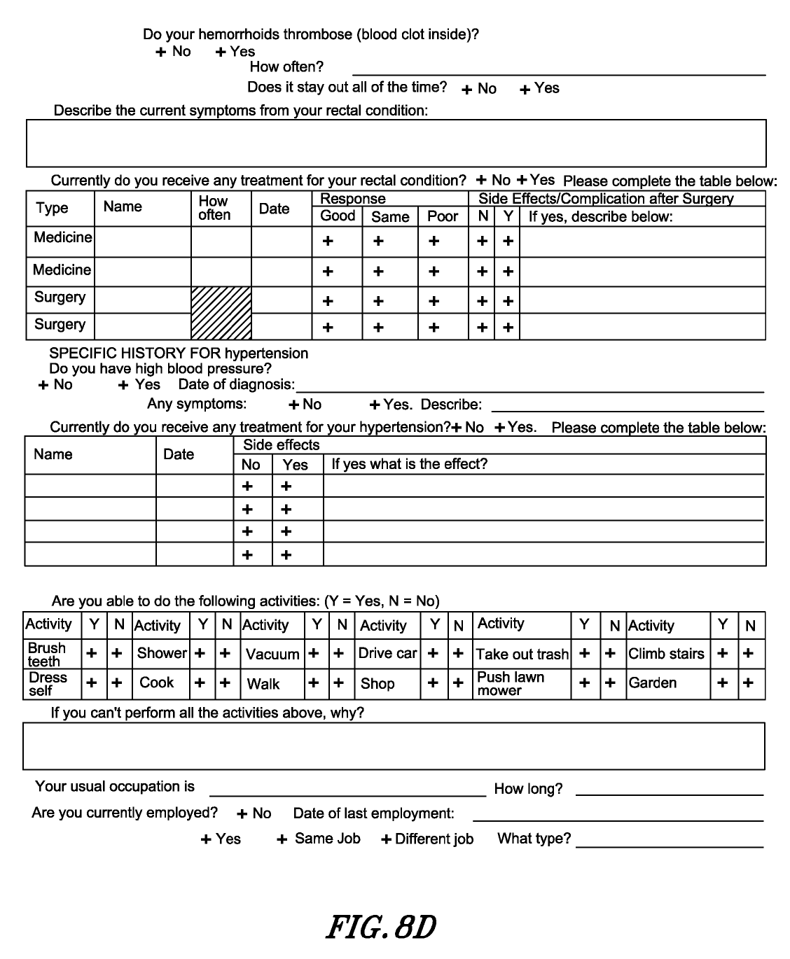

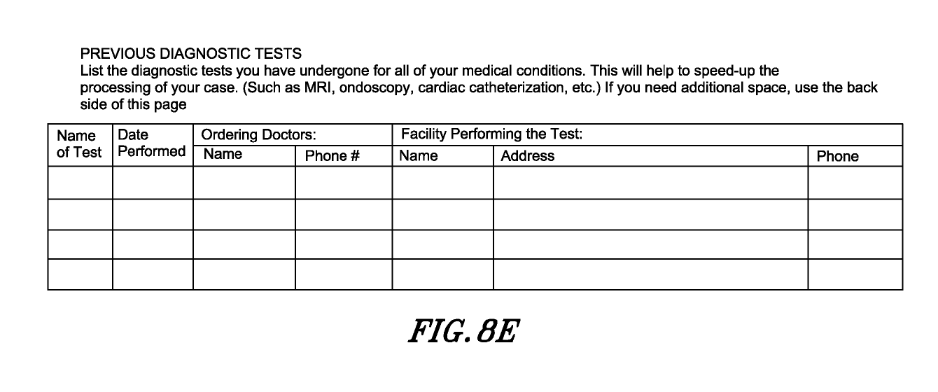

To replace or to supplement the physician's exam protocol, the component 136 may create a claimant questionnaire for those queries that can be satisfied by collecting answers directly from the claimant. FIGS. 8A-8E illustrate an example claimant questionnaire. The questionnaire can be filled out in paper or electronic form, by the claimant or by a clerk assisting the claimant. The questionnaire displays generated claimant-specific queries that can be satisfied by collecting answers from the claimant. The data entered into the questionnaire is then stored as collected medical evidence corresponding to the displayed queries. The data can be stored with the FIDs as described above, and preferably displayed to the physician for review or verification.

The clerk's data collection protocol displays generated claimant-specific queries that are to be collected from medical records. For each query, the protocol preferably displays an instruction to the clerk, for example “retrieve data from previous x-ray charts.” The instructions can be retrieved from instructions stored in the knowledge library 118 that are associated with stored general medical evidence queries. In another embodiment, the system automatically notifies a custodian of medical records via email, voice mail or paper report to search for the medical evidence specified by the queries.

In yet another embodiment, the disability benefits claims system is connected to an electronic data storage that stores existing medical records as EMR, in, for example, a claimant database 160. The electronic data storage may comprise any type of computer-readable media, including hard disk drives, removable magnetic disks, removable optical disks, magnetic cassettes, flash memory cards, digital video disks, Bernoulli cartridges, random access memories, read-only memories, and the like. The claims system, via an electronic records querying component (not shown), may automatically search the data storage and collect required medical evidence from the EMR. If the claimant database 160 is encrypted, or if access to this database is otherwise restricted, the claims system may be configured to store the requisite authentication in order to access the database 160 freely. In another embodiment, the clerk or medical provider may be required to provide such authentication before the disability benefits claims system can access the database 160.

The claims system may communicate with the claimant database 160 by any of a variety of electronic communications methods well known to those of skill in the art, including over a local area network, a wide area network, the internet (preferably an encrypted internet connection), a phone line, etc. As is well understood by those of skill in the art, the terms “over” and “through” in reference to network access are used synonymously; thus, one may access data over the internet or through the internet. In a preferred embodiment, the claimant database 160 stores medical evidence in a format that may easily be correlated to the medical evidence queries. For example, the claimant database 160 may be formatted to a particular standard that is widely adopted, and which facilitates access by other applications that have also adopted the particular standard (e.g., Snomed). However, in other embodiments, the claims system may comprise sophisticated protocols for querying the database and for correlating the queries with meaningful evidence.

In order to improve the efficiency of the process, the claims system may first search the electronic data storage for medical evidence that is responsive to the generated claimant-specific queries. In one embodiment, the system may separate the exam queries from the medical record queries only after all possible claimant-specific queries have been answered using the evidence in the EMR. In another embodiment, as illustrated, the protocols 134, 136 may be created before the claimant database 160 is interrogated. In another, transitional embodiment, the claims system may simultaneously search the electronic data storage, and also provide a clerk's protocol according to which the claimant-specific queries may be answered from older, paper-based medical records.

Follow-up Queries based on Collected Medical Evidence

The query creation component 122 may create conditional claimant-specific queries. For example, if a required exam reveals an abnormal condition, then additional medical evidence may be required according to the rules collection 112 or according to medical knowledge 114. Such additional medical evidence queries are called conditional queries. The query whose medical evidence may trigger the conditional queries is called a triggering query. A triggering query may be associated with one or more sets of conditional queries. For example, a positive result of a laboratory test for a triggering query requires a first set of conditional queries, and a negative result may require a second set of conditional queries.

In one embodiment, the FID of a triggering query stored in the knowledge library 118 includes a list of the FIDs of the conditional queries. In another embodiment, each query is stored as an object in the knowledge library 118, and a triggering query object includes pointers to point to its conditional query objects. In yet another embodiment, the FID of a triggering query includes a flag code to indicate it is a triggering query. A triggering query table includes a first field that stores the FID of a triggering query and a second field that stores the FIDs of the corresponding conditional queries. In each embodiment, the knowledge library 118 may also store a triggering rule that indicates under what conditions the conditional queries are needed, for example “when the triggering query returns a positive test result” or “when the triggering query's medical evidence is not available.”

Regardless of the storage embodiments, when the claimant-specific query creation component 122 generates a triggering query as a claimant-specific query, the conditional queries for the triggering query are preferably also generated as claimant-specific queries. The protocol creation components 134 and 136 identify a triggering query, and preferably display its corresponding conditional queries immediately following the triggering query. The medical provider's exam protocol, clerk's data collection protocol and claimant's questionnaire preferably include instructions to explain the triggering rules, for example “if this test result is positive, then answer the following questions.”

The conditional queries can be displayed after the medical evidence for the triggering query is collected. For example, a medical provider's exam protocol is displayed to the medical provider on the screen of an electronic device, and the medical provider enters collected medical evidence into the electronic device. As the medical provider enters the medical evidence for a triggering query into the electronic device, the system 100 compares the entered medical evidence with the triggering query's triggering rule stored in the knowledge library 118, and displays the conditional queries according to the triggering rule. If the conditional queries are to be collected from physical exams, they are displayed on the electronic device or on an additional paper report. The conditional queries can also be displayed on a claimant questionnaire or clerk's data collection protocol, in electronic or paper form.

Creating Medical Report

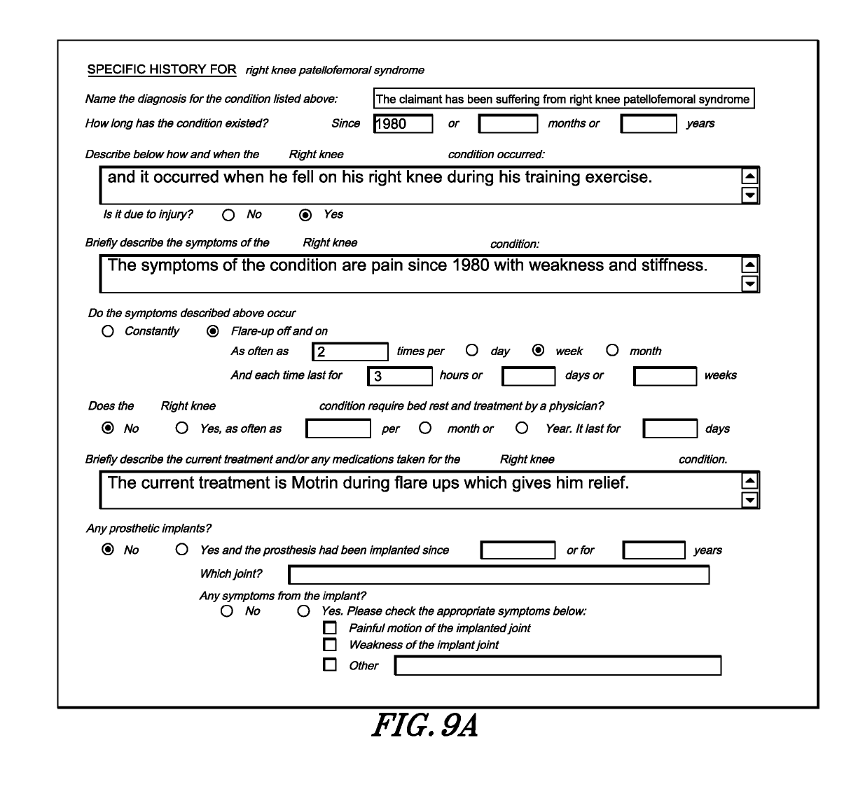

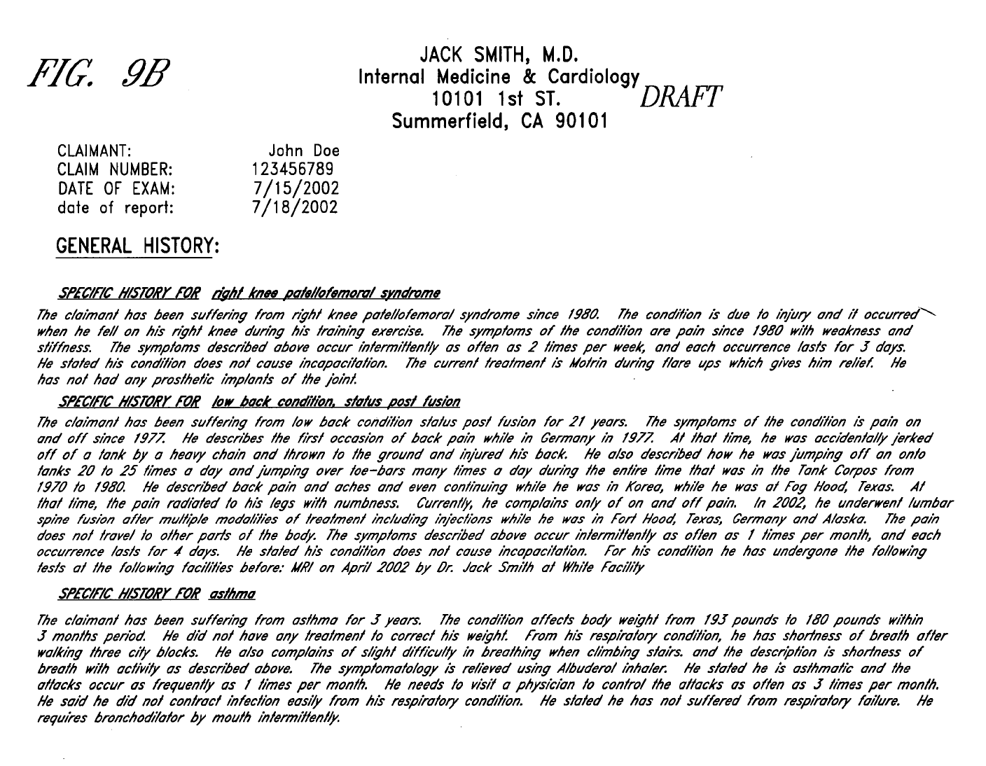

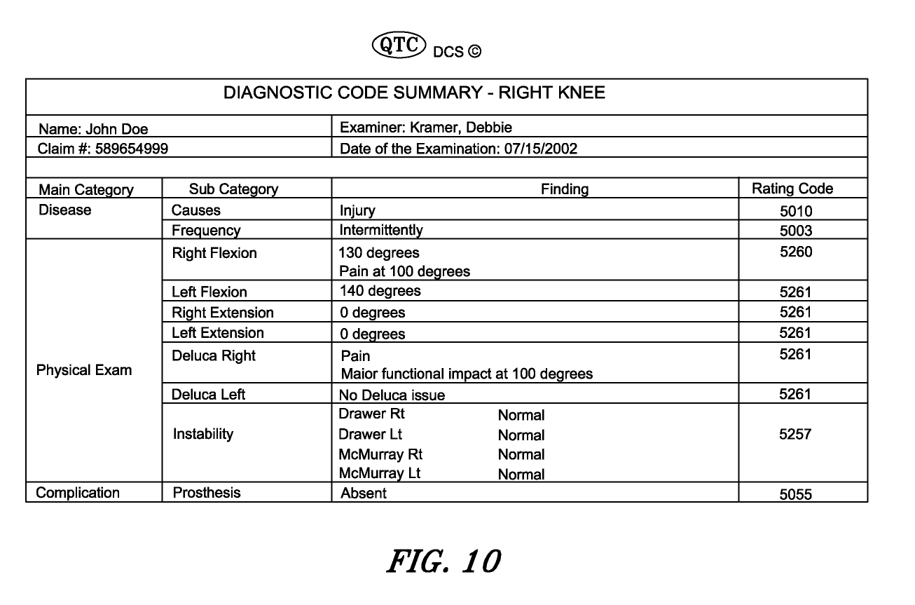

Referring back to FIG. 1, after medical evidence is collected from physical examinations, laboratory tests, medical records and claimant questionnaire, the collected medical evidence is used by a medical report creation component 142 to create a medical report. FIGS. 9A-9B and FIG. 10 illustrate two example medical reports. FIGS. 9A-9B illustrate a sample narrative report. It includes collected medical evidence, for example medical history data and other data, in preferably a narrative form.

FIG. 10 illustrates a sample diagnostic code summary report. For a claimed right knee medical condition, the report displays a summary of claimant-specific queries and medical evidences, and corresponding rating codes such as “5010” and “5003”. In one preferred embodiment described above, the FID for each query includes a category code, a rating code and a data query code. The rating code of the FID is thus displayed along with the collected medical evidence of the query. The report thus displays direct relationships of medical conditions, medical evidence and rating codes.

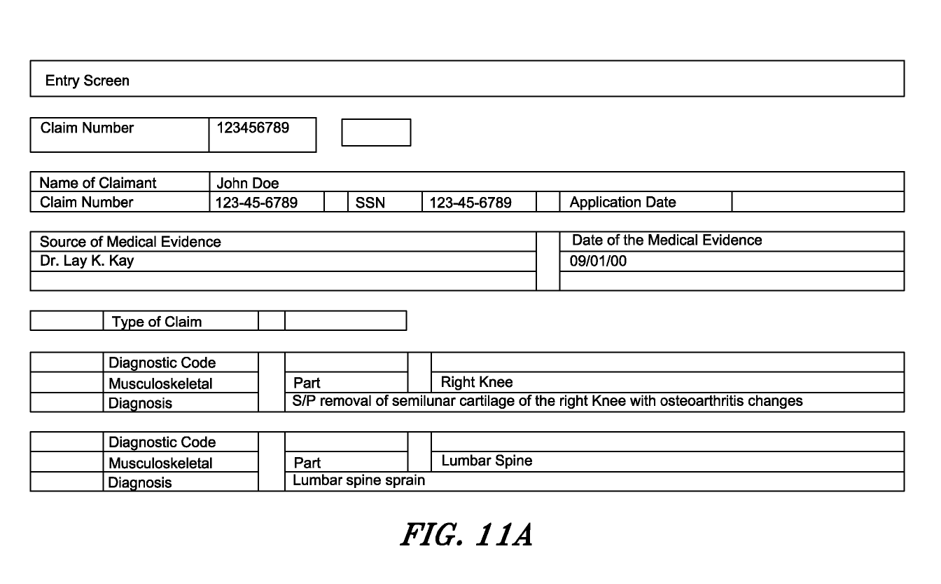

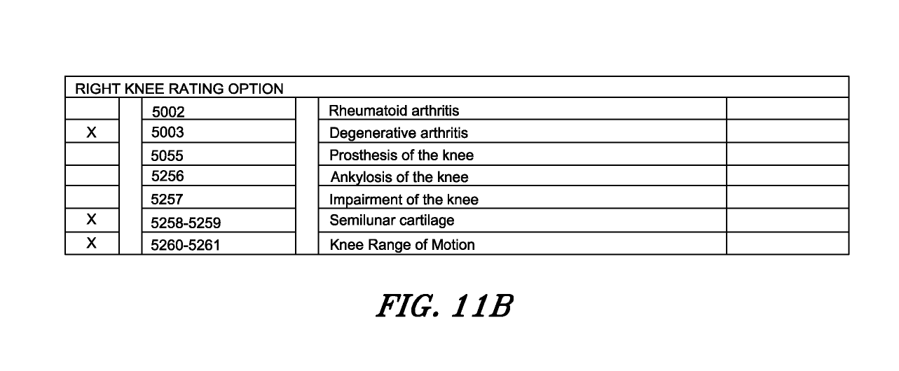

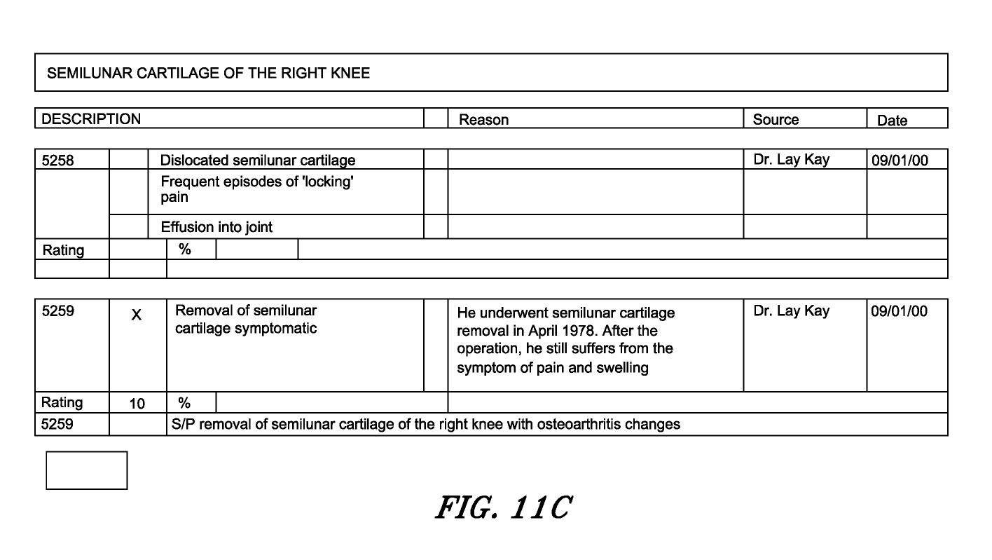

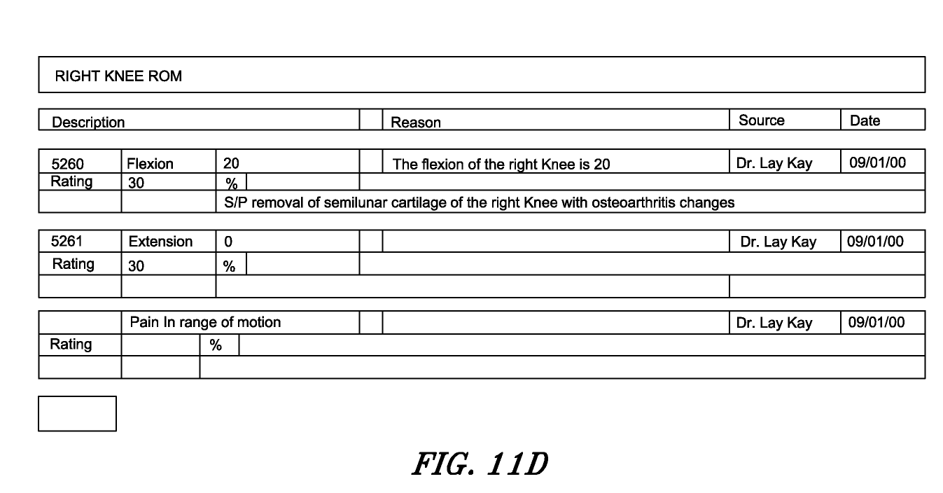

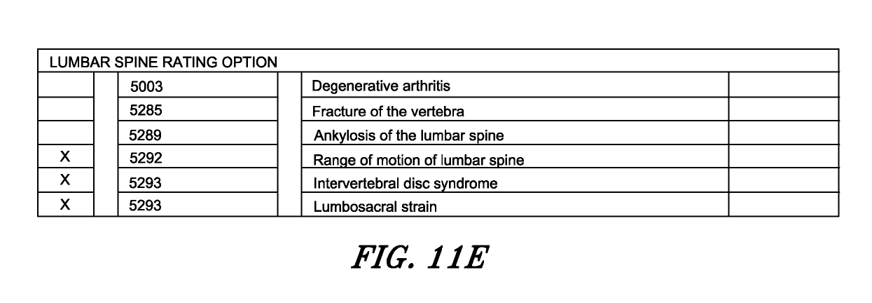

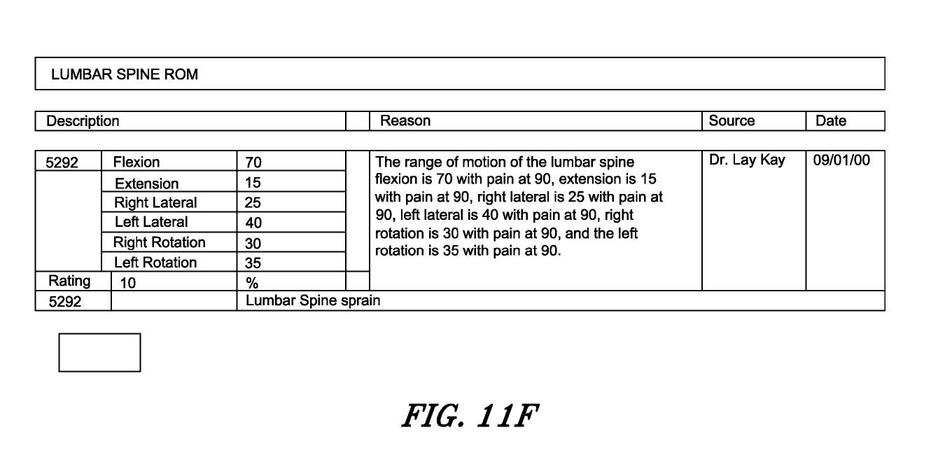

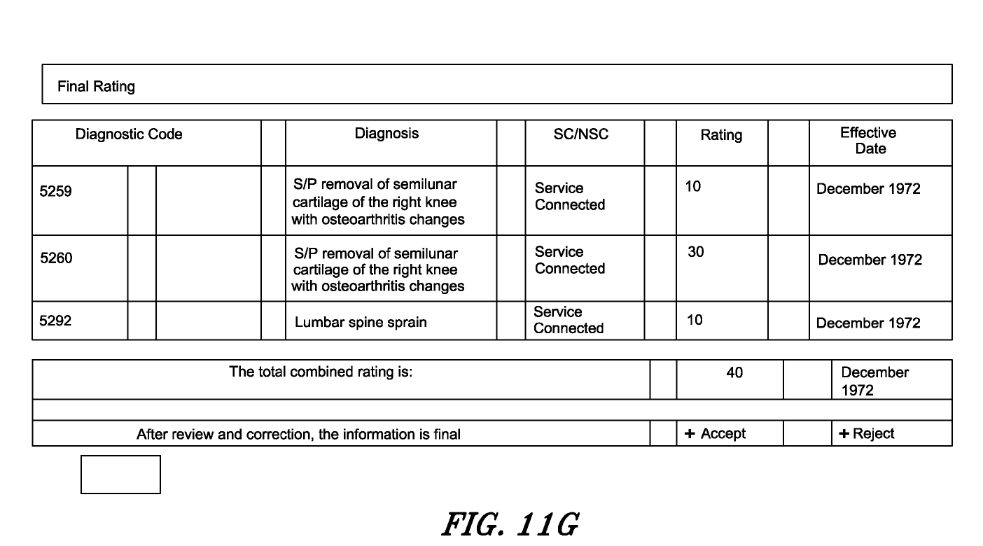

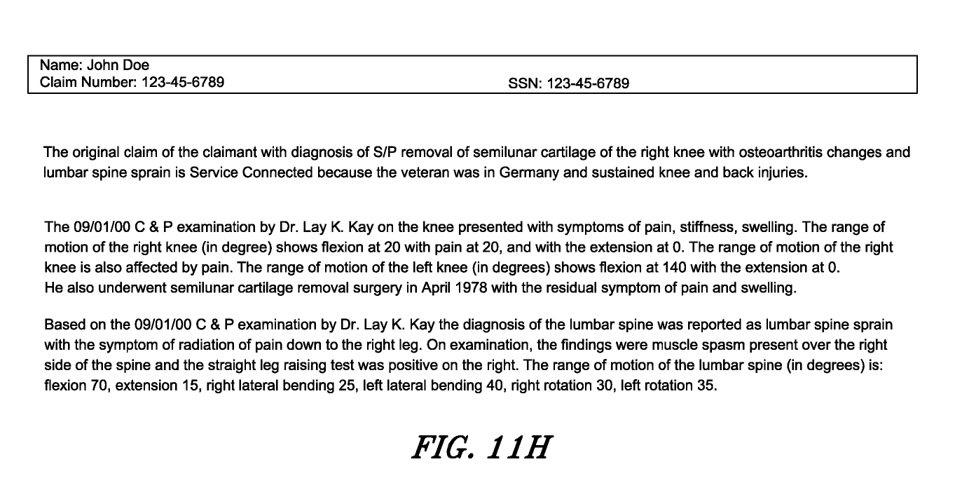

The medical report can be used by medical providers to review the claimant's medical evidence and to familiarize the medical providers with the associated rating codes. The report can also be used by rating personnel to review the claimant's medical evidence and associated rating codes. In some embodiments, medical reports can be used interchangeably with rating reports, which are described below in connection with FIGS. 11A-11H.

Depending on the insurance or disability program, reports of different formats can be generated to conform to the commonly accepted format of the particular program. For example, the medical evidence queries can be grouped by disease system on a report for a first insurance program, and grouped by module on another report for a second disability program.

Creatint Ratint Report

Referring back to FIG. 1, the rating report creation component 152 creates a rating report to assist rating personnel to adjudicate the insurance or disability requests of the claimant. FIGS. 11A-11H illustrate an example rating report, also called a rating decision toolkit.

In one embodiment, the rating report creation component 152 also recommends a rating decision to the rating personnel. The rating decision can be generated based on a set of mathematical formulas, a rule-based system, an expert system, a self-learning neural network, a fuzzy logic system, and so forth. The recommended rating decision can be generated in the form of a numerical value representing a disability percentage, a numerical value representing the insurance benefits dollar amount, a binary value representing a decision to grant or deny an insurance request, and so forth. As shown in FIG. 11C, for the rating code “5259”, the component 152 recommends a V.A. rating of “10”, i.e., a disability percentage of 10%. FIG. 11G displays a summary of all rating codes and corresponding recommended disability percentages, and a recommended combined disability percentage. The rating personnel can review the rating report and accept, reject or modify the recommended ratings.

The disclosed disability claims benefits system 100 can be implemented in a variety of computer languages, commercial applications and operating platforms. For example, the system can be implemented in whole or in part in Visual Basis, C, SQL, and so forth.

Associating Health Condition Classification Code(s) with Rating Diagnostic Code(s)

The disability rating process may be improved by extending the use of an examining physician's medical expertise in the adjudication process. This will shorten the training time required to develop competency and increase the productivity of ratings specialists.

The rating process is comprised of two major components, a medical component and an adjudication component. Part of the ratings specialist's extensive training is to learn and understand the relationship of medical terminology, symptoms, diagnoses and, at times, specific and complex diagnostic test results and applying that knowledge to rating the claim. Becoming competent in both a disability evaluation compensation and pension program's (e.g., the Veterans Affairs Compensation and Pension Program) regulations and the associated medical elements is a lengthy process and adds additional time to the rating of claims. Physicians who have been trained to conduct disability evaluation compensation and pension program evaluations, such as by utilizing the Veterans Affairs (V.A.) Automated Medical Information Exchange (AMIE) worksheet requirements, and who understand the medical evidence requirements of the V.A. program, can be utilized more effectively in the rating process. Leveraging the knowledge and expertise of a trained physician can expedite the rating process and lessen the burden on a ratings specialist. The examining physician can therefore apply their medical expertise and knowledge of V.A. requirements to both the disability exam protocols and to the rating diagnostic code medical content associated with the disability examination. The rating diagnostic code categories describe very specific subjective and objective findings including medical symptoms, physical findings and even complex diagnostic test results. Each clinical diagnosis can have associated content in the rating diagnostic code that can be presented to the physician for their input.

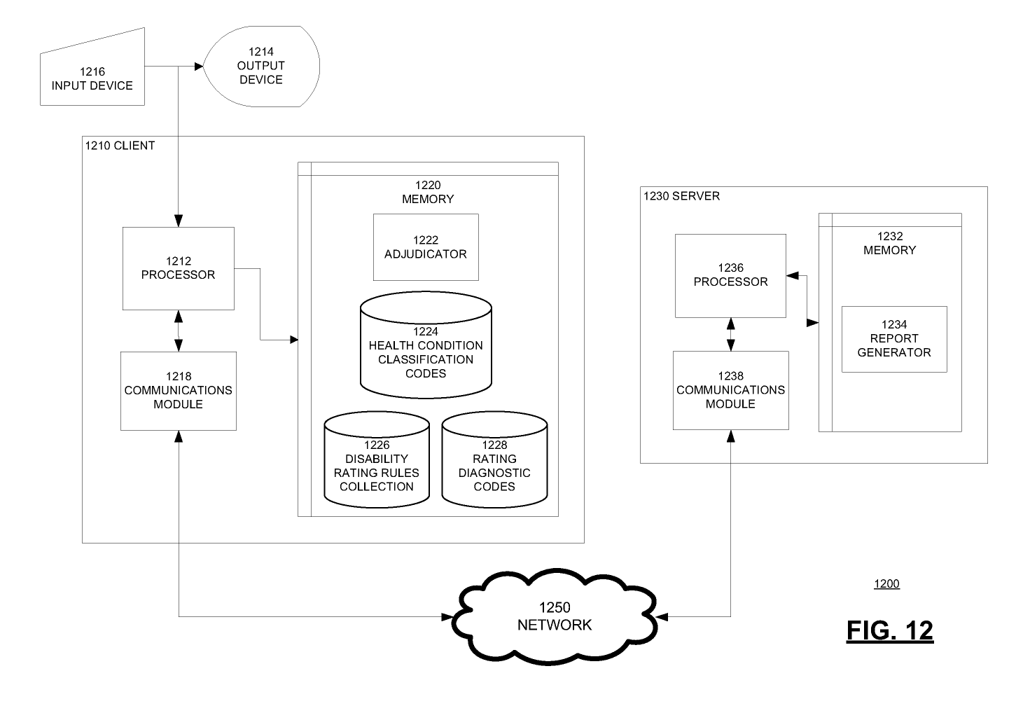

With reference back to the drawings, FIG. 12 illustrates an exemplary client 1210 and server 1230 in an architecture 1200 for adjudicating a medical disability request. The architecture 1200 includes a client 1210 and a server 1230 connected over a network 1250 via respective communications modules 1218 and 1238. The network 1250 can include, for example, any one or more of a personal area network (PAN), a local area network (LAN), a campus area network (CAN), a metropolitan area network (MAN), a wide area network (WAN), a broadband network (BBN), the Internet, and the like. Further, the network 1250 can include, but is not limited to, for example, any one or more of the following network topologies, including a bus network, a star network, a ring network, a mesh network, a star-bus network, tree or hierarchical network, or the like. The communications modules 1218 and 1238 can be, for example, modems or Ethernet cards.

The client 1210 includes a processor 1212, a communications module 1218, an input device 1216, an output device 1214, and a memory 1220. The memory includes an adjudicator 1222, health condition classification codes 1224, a disability rating rules collection 1226, and rating diagnostic codes 1228. The client 1210 can be, for example, a desktop computer, a mobile computer, a mobile device, or any other device having appropriate components for the capabilities described herein.

The processor 1212 of the client 1210 is configured to execute instructions, such as instructions physically coded into the processor 1212, instructions received from software in memory 1220, or a combination of both. For example, the processor 1212 of the server 1230 is configured to execute instructions from the adjudicator 1222 causing the processor 1212 to receive an indicator of a diagnosis of a medical condition of a claimant. The indicator of the diagnosis can be received from a user, such as a healthcare professional, using the input device 1216, such as a keyboard. The indicator of the diagnosis can also be received from an electronic health record for the claimant. The diagnosis can be, for example, tentative or final, and an indicator of an injury, disease, sign, symptom, abnormal finding on a physical exam, abnormal lab finding, claimant complaint, social circumstance, and an external cause of an injury or a disease.

The processor 1212 also executes instructions to present, to the user, from a predetermined set of health condition classification codes 1224, at least two health condition classification codes based on the diagnosis. The health condition classification codes can be presented on the output device 1214 of the client 1210, such as a display. The presentation of the two or more health condition classification codes includes excluding health condition classification codes, from the predetermined set of health condition classification codes 1224, which are not specific to at least one of the diagnosis and the claimant. The health condition classification codes 1224 each represent a classification of at least one of an injury, disease, sign, symptom, abnormal finding on a physical exam, abnormal lab finding, claimant complaint, social circumstance, and an external cause of an injury or a disease. The health condition classification codes 1224 can include International Classification of Disease (ICD) codes, such as the 9th Edition ICD codes (ICD-9 codes). In certain embodiments, the set of health condition classification codes 1224 contains a greater number of health condition classification codes than the number of health condition classification codes that are presented to the user.

The processor 1212 executes instructions to receive, from the user, a selection of at least one of the health condition classification codes that are presented to the user. The processor 1212 also executes instructions to associate, based on a disability rating rules collection 1226, the selected health condition classification code(s) with at least one rating diagnostic code selected from a predetermined set of rating diagnostic codes. The rating diagnostic code is used to determine a degree of disability of the claimant and an indicator of an amount of money to be paid to the claimant by the payor. The processor can also execute instructions to receive a selection of a multiple health condition classification codes, and then associate, based on the disability rating rules collection 1226, the selected health condition classification codes with the rating diagnostic code(s) selected from a predetermined set of rating diagnostic codes.

As discussed herein, the disability rating rules collection 1226 includes requirements specified by rules developed by a government agency or by an insurance company, ratings codes, pertinent case law, government regulations, legislation and administrative decisions, and so forth. For example, the requirements may specify that if a claimant claims a certain medical condition, a medical provider must conduct certain physical examinations and laboratory tests on the claimant or ask certain questions. The requirements may also specify, for example, that a claimant must have a range of motions less than a certain degree to claim a limb disability. Requirements can also be specified by conventional medical knowledge, for example requiring a certain test to confirm a particular claimed condition. The rating rules are normally documented in manuals that may have many different titles, herein referred to as “rating books.” A rating code refers to a classification used by the government agency or insurance company that typically refers to a medical condition or a class of medical conditions in a rating book. The rating rules may include rules on how to make a rating decision based on the collected medical evidence and the rating codes. For example, in a V.A. disability program, the rules collection typically specifies a disability percentage range based on rating codes and collected medical evidence. A V.A. rating personnel reviews the rating codes and medical evidence, and specifies a disability percentage within the range. Additional information on disability rating rules collections is discussed in U.S. patent application Ser. No. 122/962,616 entitled “Automated Processing of Electronic Medical Data for Insurance and Disability Determinations,” incorporated by reference herein in its entirety.

The association of the selected health condition classification code(s) with the rating diagnostic code can be based on a predetermined set of rules that is based on a history of the claimant, co-morbidities associated with the claim, an amount of money already received andor being received by the claimant. The amount of money to be paid to the claimant by the payor can be based on a relative weighting of rating diagnostic codes selected from the predetermined set of rating diagnostic codes. For example, a rating diagnostic code indicating a higher level of disability or a higher chance of morbidity can be weighted more heavily than a rating diagnostic code indicating a lower level of disability or a lower chance of morbidity. The amount of money can also be based on another weight, namely, a weight determined by a history of the claimant, co-morbidities associated with the claim, an amount of money already received andor being received by the claimant. For example, if the history of the claimant indicates a higher level of distress, or if the claimant has not received any money or is not receiving any money, then the weighting can be greater than if the history of the claimant indicates a lower level of distress, or if the claimant has received or is receiving substantial money.

The processor 1212 is further configured to execute instructions to receive, from the user, an indicator of a degree of disability associated with the diagnosis and the selected health condition classification code(s). For example, when the user is selecting the health condition classification code(s), the user may also select a degree of disability associated with the diagnosis indicated by the selected health condition classification code(s). The selected health condition classification code(s) can themselves include a degree of disability associated with the diagnosis indicated by the selected health condition classification code(s). In such cases, the association of the selected health condition classification code(s) with the rating diagnostic code(s) is based on the indicator of the degree of disability received from the user.

The 1212 processor of the client 1210 can execute instructions to transmit the selected rating diagnostic code(s) to a second user who determines the degree of disability of the claimant and the indicator of the amount of money to be paid to the claimant by the payor. The second user can, for example, be located at the server 1230, and the selected rating diagnostic code(s) can be received by a report generator 1234 in a memory 1232 of the server 1230. The server 1230, which includes a processor 1236, the communications module 1238, and the memory 1232, can then be used by the second user to determine the degree of disability of the claimant and the indicator of the amount of money to be paid to the claimant by the payor. The determined degree of disability of the claimant and the indicator of the amount of money to be paid to the claimant by the payor can be output in a report generated by the report generator 1234.

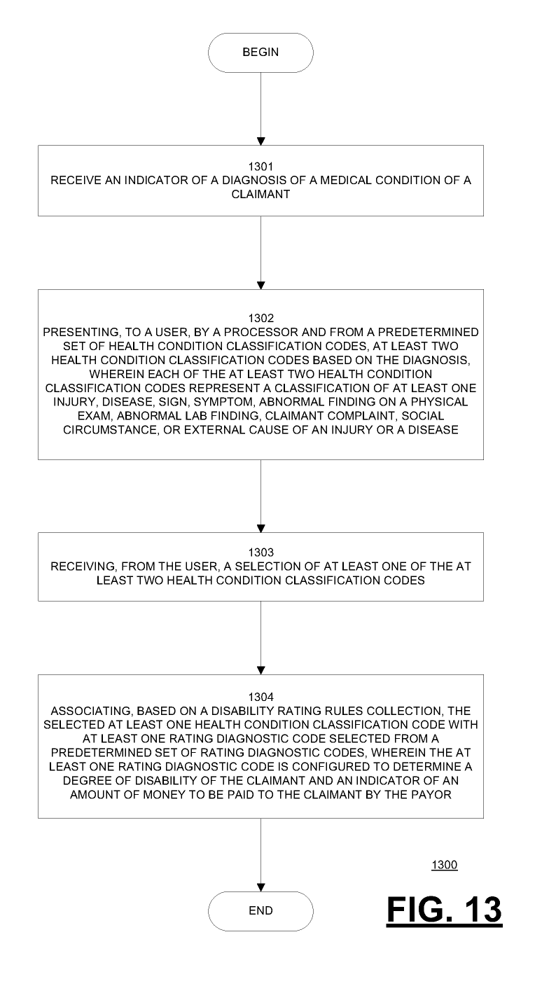

FIG. 13 illustrates an exemplary process 1300 for adjudicating, for a payor, a medical disability request using the exemplary client 1210 of FIG. 12. The process 1300 begins in step 1301, in which an indicator of a diagnosis of a medical condition of a claimant is received by the client 1210. In step 1302, a user is presented, by the processor 1212 and from a predetermined set of health condition classification codes 1224, at least two health condition classification codes based on the diagnosis. In step 1303, a selection of at least one of the at least two health condition classification codes is received from the user. In step 1304, the selected health condition classification code is associated with at least one rating diagnostic code selected from a predetermined set of rating diagnostic codes 1228 based on the disability rating rules collection 1226. The process 1300 then ends.

Having set forth in FIG. 13 an exemplary process 1300 for adjudicating a medical disability request using the exemplary client 1210 of FIG. 12, an example will now be presented using a claimant complaining of chest pain. The process 1300 begins in step 1301, after a physician sees a claimant complaining of chest pain. The physician in step 1301 uses a user interface for the adjudicator 1222 of the client to enter a possible diagnosis of arteriosclerosis.

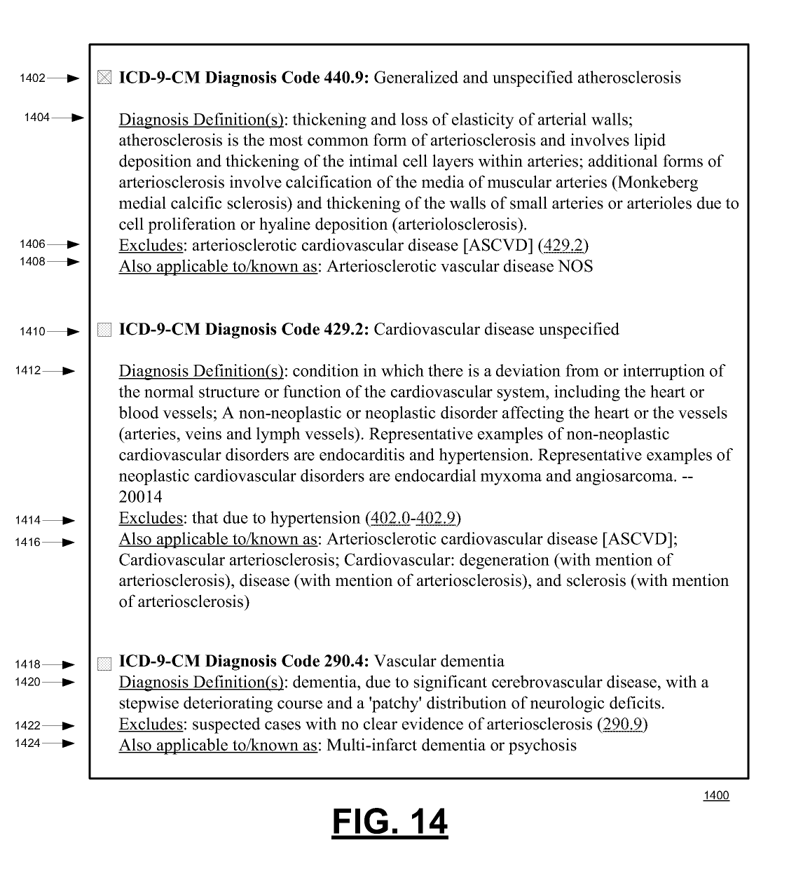

Based on available data (e.g., including the physician's diagnosis), a list of possible clinical diagnoses related to disability determinations, including compensation and pension exams is determined and made available to the physician in step 1302. The physician is presented in step 1302 with the three ICD-9 codes 1402, 1410, and 1418 illustrated in FIG. 14, which is an exemplary screenshot 1400 from the adjudicator 1222. The three ICD-9 codes 1402, 1410, and 1418 are selected, based on the diagnosis of arteriosclerosis, by the processor 1212 from a predetermined, larger set of ICD-9 codes 1224. Each of the displayed ICD-9 codes 1402, 1410, and 1418 includes a diagnosis definition 1404, 1412, and 1420, a related excluded diagnosis 1406, 1414, and 1422, and related applicationsnames 1408, 1416, and 1424.

In step 1303, based on the claimant's medical evidence, which includes the Compensation and Pension Examination Report and available medical evidence in C-files, the physician matches the clinical diagnosis of arteriosclerosis to the appropriate ICD-9 codes and selects the ICD-9 diagnosis code 440.9 for “generalized and unspecified atherosclerosis” 1402, as illustrated by the checked box 1403 in FIG. 14. The physician matches the diagnosis to the appropriate ICD-9 code based on findings and evidence obtained during the physician's evaluation of the patient. The ICD-9 code selected by the physician is intended to indicate the appropriate level of functional disability that best describes the nature and severity of the claimant's diagnosis according to ICD-9. The description of the selected ICD-9 code, including any level of functional impairment corresponding to the selected rating ICD-9 code, is provided in the screenshot 1400 to the physician to choose from based on the physician's evaluation. The rating criteria for each ICD-9 code, appropriate to the disability diagnosed, can be appended to the physician's examination report.

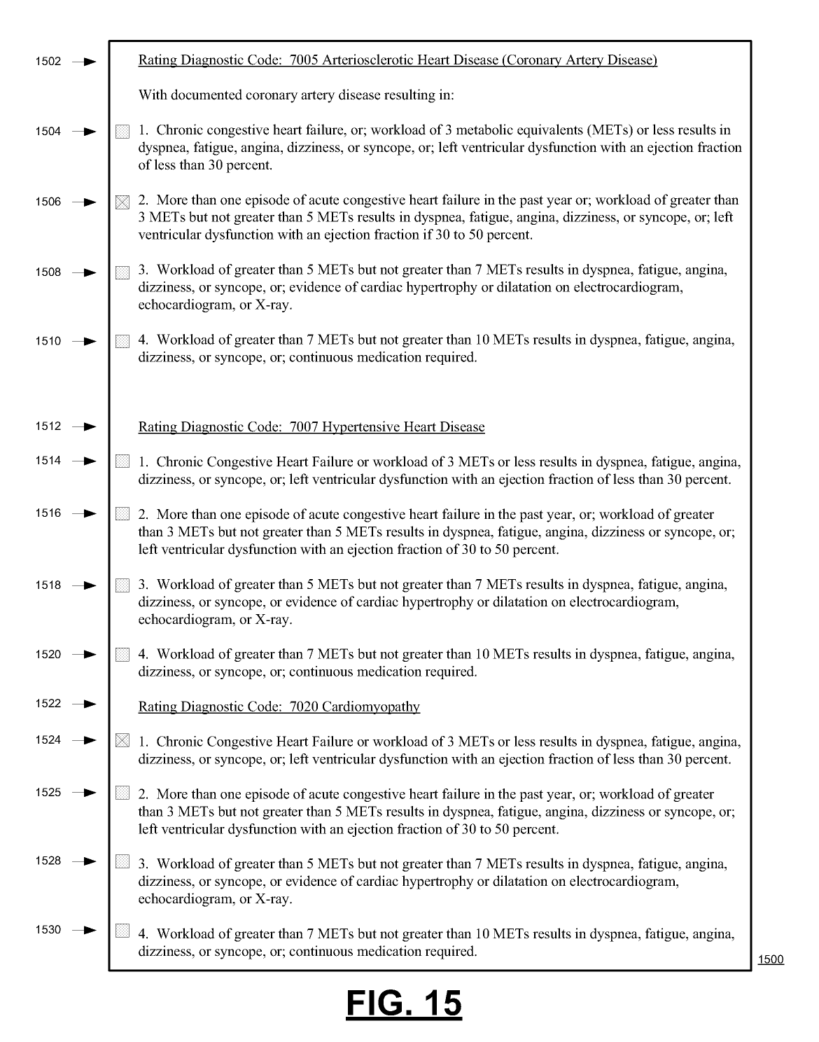

In step 1304, the selected ICD-9 diagnosis code 440.9 for “generalized and unspecified atherosclerosis” 1402 is associated with rating diagnostic codes selected from the predetermined set of rating diagnostic codes 1228 based on the disability rating rules collection 1226. FIG. 15 illustrates an exemplary screenshot 1500 of the selected rating diagnostic codes to be “7005 Arteriosclerotic Heart Disease” 1502, “7007 Hypertensive Heart Disease” 1512, and “7020 Cardiomyopathy” 1522. The selected ratings codes 1502, 1512, and 1522 are included from the content from the Code of Federal Regulations Title 38 (CFR 38).

Each of the selected rating diagnostic codes 1502, 1512, and 1524, has four associated degrees of disability: 1504, 1506, 1508, and 1510 for “7005 Arteriosclerotic Heart Disease” 1502, 1514, 1516, 1518, and 1520 for “7007 Hypertenstive Heart Disease” 1512, and 1524, 1526, 1528, and 1530 for “7020 Cardiomyopathy” 1522.

The association of ICD-9 diagnosis code 440.9 for “generalized and unspecified atherosclerosis” 1402 with the second degree of disability 1506 for “7005 Arteriosclerotic Heart Disease” 1502 and the first degree of disability 1524 1530 for “7020 Cardiomyopathy” 1522 in based on a predetermined set of rules that is based on a history of the claimant, co-morbidities associated with the claim, an amount of money already received and/or being received by the claimant.

The results of the disability examination, including the selected rating diagnostic codes 1500, and optionally guidance regarding the selected rating diagnostic codes 1500, are provided to a ratings specialist to undergo a quality assurance review process (e.g., before submission to the V.A.). The ratings specialist can receive a compensation and pension examination report that includes the selected rating diagnostic codes 1500 with the appropriate level of medical impairment identified by the physician. This reduces the time required for adjudication of the medical aspects of the claimant's case, including time required by the ratings specialist. Under the disclosed system, the ratings specialist can apply the adjudication non-medical procedures necessary to complete the rating process. This proposed process would facilitate the ability of the ratings specialist to render timely, accurate and consistent decisions. The ratings specialist continues to have the responsibility for the final disposition of the veteran's rating decision. The V.A. may later be required to evaluate all the evidence in the claimant's case record that may have a bearing on the disability determination. If the C-file contains further medical evidence, the ratings specialist is not precluded from re-categorizing the disability impairment or the ratings specialist may seek additional clarification from the physician or psychologist. This recommendation allows the physician to be the medical expert and the ratings specialist to be the adjudication expert.

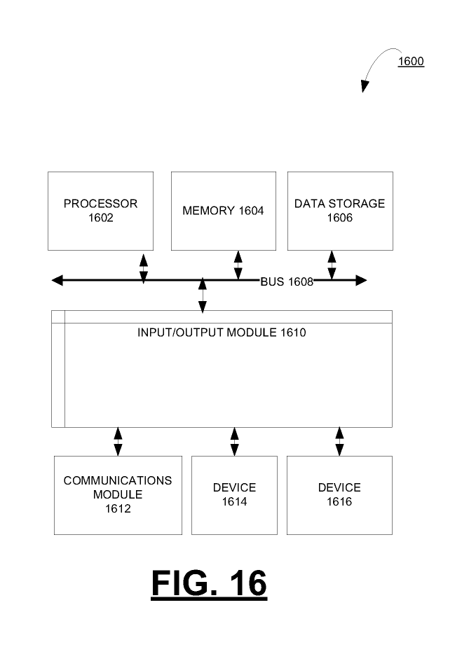

FIG. 16 is a block diagram illustrating an exemplary computer system 1600 with which the client 1210 and server 1230 of FIG. 12 can be implemented. In certain aspects, the computer system 1600 may be implemented using hardware or a combination of software and hardware, either in a dedicated server, or integrated into another entity, or distributed across multiple entities.

Computer system 1600 (e.g., client 1210 and servers 1230) includes a bus 1608 or other communication mechanism for communicating information, and a processor 1602 (e.g., processor 1212 and 1236) coupled with bus 1608 for processing information. By way of example, the computer system 1600 may be implemented with one or more processors 1602. Processor 1602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1600 can include, in addition to hardware, code that creates an execution environment for the computer program in question, e.g., code that constitutes processor firmware, a protocol stack, a database management system, an operating system, or a combination of one or more of them stored in an included memory 1604 (e.g., memory 1220 and 1232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1608 for storing information and instructions to be executed by processor 1602. The processor 1602 and the memory 1604 can be supplemented by, or incorporated in, special purpose logic circuitry.

The instructions may be stored in the memory 1604 and implemented in one or more computer program products, i.e., one or more modules of computer program instructions encoded on a computer readable medium for execution by, or to control the operation of, the computer system 1600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1604 may also be used for storing temporary variable or other intermediate information during execution of instructions to be executed by processor 1602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1600 further includes a data storage device 1606 such as a magnetic disk or optical disk, coupled to bus 1608 for storing information and instructions. Computer system 1600 may be coupled via inputoutput module 1610 to various devices (e.g., input device 1216 and output device 1214). The inputoutput module 1610 can be any inputoutput module. Exemplary inputoutput modules 1610 include data ports such as USB ports. The inputoutput module 1610 is configured to connect to a communications module 1612. Exemplary communications modules 1612 include networking interface cards, such as Ethernet cards and modems. In certain aspects, the inputoutput module 1610 is configured to connect to a plurality of devices, such as an input device 1614 (e.g., input device 1216) andor an output device 1616 (e.g., output device 1214). Exemplary input devices 1614 include a keyboard and a pointing device, e.g., a mouse or a trackball, by which a user can provide input to the computer system 1600. Other kinds of input devices 1614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1616 include display devices, such as a CRT (cathode ray tube) or LCD (liquid crystal display) monitor, for displaying information to the user.

According to one aspect of the present disclosure, the client 1210 and server 1230 can be implemented using a computer system 1600 in response to processor 1602 executing one or more sequences of one or more instructions contained in memory 1604. Such instructions may be read into memory 1604 from another machine-readable medium, such as data storage device 1606. Execution of the sequences of instructions contained in main memory 1604 causes processor 1602 to perform the process steps described herein. One or more processors in a multi-processing arrangement may also be employed to execute the sequences of instructions contained in memory 1604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network.

Computing system 1600 can include clients and servers. A client and server are generally remote from each other and typically interact through a communication network. The relationship of client and server arises by virtue of computer programs running on the respective computers and having a client-server relationship to each other. Computer system 1600 can also be embedded in another device, for example, and without limitation, a mobile telephone, a personal digital assistant (PDA), a mobile audio player, a Global Positioning System (GPS) receiver, a video game console, andor a television set top box.

The term “machine-readable storage medium” or “computer readable medium” as used herein refers to any medium or media that participates in providing instructions to processor 1602 for execution. Such a medium may take many forms, including, but not limited to, non-volatile media, volatile media, and transmission media. Non-volatile media include, for example, optical or magnetic disks, such as data storage device 1606. Volatile media include dynamic memory, such as memory 1604. Transmission media include coaxial cables, copper wire, and fiber optics, including the wires that comprise bus 1608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A method for adjudicating, for a payor, a medical disability request, comprising:
receiving an indicator of a diagnosis of a medical condition of a claimant;
presenting to a user by a processor and from a predetermined set of health condition classification codes, at least two health condition classification codes based on the diagnosis;
receiving from the user a selection of at least one of the at least two health condition classification codes; and
associating, based on a disability rating rules collection, the selected at least one health condition classification code with at least one rating diagnostic code selected from a predetermined set of rating diagnostic codes;
wherein each of the at least two health condition classification codes represents a classification of at least one of an injury, disease, sign, symptom, abnormal finding on a physical exam, abnormal lab finding, claimant complaint, social circumstance, and an external cause of an injury or a disease; and
wherein the at least one rating diagnostic code is configured to determine a degree of disability of the claimant and an indicator of an amount of money to be paid to the claimant by the payor.

2. The method of claim 1, wherein the at least two health condition classification codes comprise International Classification of Disease (ICD) codes.

3. The method of claim 1, wherein the amount of money is based on a relative weighting of at least two rating diagnostic codes selected from the predetermined set of rating diagnostic codes.

4. The method of claim 3, wherein the amount of money is based on another weight determined by at least one of a history of the claimant, co-morbidities associated with the claim, an amount of money already received andor being received by the claimant.

5. The method of claim 1, wherein the associating the selected at least one health condition classification code with the at least one rating diagnostic code is based on a predetermined set of rules that is based on a history of the claimant, co-morbidities associated with the claim, an amount of money already received andor being received by the claimant.

6. The method of claim 5, further comprising receiving from the user an indicator of a degree of disability associated with the diagnosis and the selected at least one health condition classification code, and wherein the association of the selected at least one health condition classification code with the at least one rating diagnostic code is based on the indicator of the degree of disability received from the user.

7. The method of claim 1, wherein the presenting the at least two health condition classification codes comprises excluding health condition classification codes, from the predetermined set of health condition classification codes, that are not specific to at least one of the diagnosis and the claimant.

8. The method of claim 1, wherein the set contains a greater number of health condition classification codes than the at least two health condition classification codes.

9. The method of claim 1, further comprising receiving a selection of a plurality of health condition classification codes from the at least two health condition classification codes, wherein the association is of the selected plurality of health condition classification codes with the at least one rating diagnostic code selected from the predetermined set of rating diagnostic codes.

10. The method of claim 1, further comprising transmitting the selected at least one rating diagnostic code to a second user who determines the degree of disability of the claimant and the indicator of the amount of money to be paid to the claimant by the payor.

11. A system for adjudicating, for a payor, a medical disability request, comprising:
a memory comprising instructions;
a processor configured to execute the instructions to:
receive an indicator of a diagnosis of a medical condition of a claimant;
present, to a user, by a processor and from a predetermined set of health condition classification codes, at least two health condition classification codes based on the diagnosis;
receive, from the user, a selection of at least one of the at least two health condition classification codes; and
associate, based on a disability rating rules collection, the selected at least one health condition classification code with at least one rating diagnostic code selected from a predetermined set of rating diagnostic codes;
wherein each of the at least two health condition classification codes represents a classification of at least one of an injury, disease, sign, symptom, abnormal finding on a physical exam, abnormal lab finding, claimant complaint, social circumstance, and an external cause of an injury or a disease; and
wherein the at least one rating diagnostic code is configured to determine a degree of disability of the claimant and an indicator of an amount of money to be paid to the claimant by the payor.

12. The system of claim 11, wherein the at least two health condition classification codes comprise International Classification of Disease (ICD) codes.

13. The system of claim 11, wherein the amount of money is based on a relative weighting of at least two rating diagnostic codes selected from the predetermined set of rating diagnostic codes.

14. The system of claim 13, wherein the amount of money is based on another weight determined by at least one of a history of the claimant, co-morbidities associated with the claim, an amount of money already received andor being received by the claimant.

15. The system of claim 11, wherein the association of the selected at least one health condition classification code with the at least one rating diagnostic code is based on a predetermined set of rules that is based on a history of the claimant, co-morbidities associated with the claim, an amount of money already received andor being received by the claimant.

16. The system of claim 15, wherein the processor is further configured to execute instructions to receive, from the user, an indicator of a degree of disability associated with the diagnosis and the selected at least one health condition classification code, and wherein the association of the selected at least one health condition classification code with the at least one rating diagnostic code is based on the indicator of the degree of disability received from the user.

17. The system of claim 11, wherein the presentation of the at least two health condition classification codes comprises excluding health condition classification codes, from the predetermined set of health condition classification codes, that are not specific to at least one of the diagnosis and the claimant.

18. The system of claim 11, wherein the set contains a greater number of health condition classification codes than the at least two health condition classification codes.

19. The system of claim 11, wherein the processor is further configured to execute instructions to receive a selection of a plurality of health condition classification codes from the at least two health condition classification codes, wherein the association is of the selected plurality of health condition classification codes with the at least one rating diagnostic code selected from the predetermined set of rating diagnostic codes.

20. The system of claim 11, wherein the processor is further configured to execute instructions to transmit the selected at least one rating diagnostic code to a second user who determines the degree of disability of the claimant and the indicator of the amount of money to be paid to the claimant by the payor.

21. A machine-readable storage medium comprising machine-readable instructions for causing a processor to execute a method for adjudicating, for a payor, a medical disability request, comprising:
receiving an indicator of a diagnosis of a medical condition of a claimant;
presenting to a user by a processor and from a predetermined set of health condition classification codes, at least two health condition classification codes based on the diagnosis;
receiving from the user a selection of at least one of the at least two health condition classification codes; and
associating, based on a disability rating rules collection, the selected at least one health condition classification code with at least one rating diagnostic code selected from a predetermined set of rating diagnostic codes;
wherein each of the at least two health condition classification codes represents a classification of at least one of an injury, disease, sign, symptom, abnormal finding on a physical exam, abnormal lab finding, claimant complaint, social circumstance, and an external cause of an injury or a disease; and
wherein the at least one rating diagnostic code is configured to determine a degree of disability of the claimant and an indicator of an amount of money to be paid to the claimant by the payor.
